(19) United States
(12) Patent Application Publication
(10) Pub. No.: US 2026/0017089 A1
(43) Pub. Date: Jan. 15, 2026

(54) SYSTEM AND METHOD FOR DYNAMICALLY SWITCHING MACHINE LEARNING RUNTIMES BEHIND AN APPLICATION INTERFACE

(71) Applicant: Dell Products LP, Round Rock, TX (US)

(72) Inventors: Jacob Mink, Cedar Park, TX (US); Srikanth Kondapi, Austin, TX (US)

(73) Assignee: Dell Products LP, Round Rock, TX (US)

(21) Appl. No.: 18/771,266

(22) Filed: Jul. 12, 2024

(51) Int. Cl. G06F 9/48

(52) U.S. Cl. CPC G06F 9/4843; G06F 2209/482

(57) ABSTRACT

A system and method of runtime switching between machine learning (ML) models during execution of computer-readable program code instructions of an artificial intelligence (AI) productivity tool module with a hardware processor of an information handling system to initiate a request, on behalf of an application being executed on the information handling system, to an AI productivity tool subagent for a first ML model algorithm. Executing a swappable wrapper generator to create a first ML model algorithm wrapper around the first ML model algorithm, and executing an inference runtime control module to monitor the hardware processor resource utilization of runtime associated with the first ML model algorithm. Executing an inference runtime control module to switch to an alternative information handling system hardware processor to execute the first ML model algorithm, and create a second wrapper around the second ML model algorithm to switch to a second ML model algorithm is appropriate.

### FIELD OF THE DISCLOSURE

The present disclosure generally relates to execution of computer-readable program code instructions for one or more artificial intelligence (AI) productivity tools. The present disclosure more specifically relates systems and methods of runtime switching between a selection of code instructions for plural machine learning model algorithms used by an AI productivity tool.

### BACKGROUND

As the value and use of information continues to increase, individuals and businesses seek additional ways to process and store information. One option available to clients is information handling systems. An information handling system generally processes, compiles, stores, and/or communicates information or data for business, personal, or other purposes thereby allowing clients to take advantage of the value of the information. Because technology and information handling may vary between different clients or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific client or specific use, such as e-commerce, financial transaction processing, airline reservations, enterprise data storage, or global communications. In addition, information handling systems may include a variety of hardware and software components that may be configured to process, store, and communicate information and may include one or more computer systems, data storage systems, and networking systems. The information handling system may include telecommunication, network communication, and video communication capabilities. The information handling system may be used to execute instructions of one or more workspace productivity applications such as for teleconferencing, word processing, sales systems, business software, gaming applications, or the like.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram illustrating an information handling system that includes an AI productivity tool and an AI productivity tool software application to select among a plurality of AI productivity tool-enablable software applications for software services, operations, or responses of those AI productivity tool-enablable software applications according to an embodiment of the present disclosure;

FIG. 2 is a graphic and block diagram illustrating an information handling system that includes an AI productivity tool module and an AI productivity tool software application to select and switch among a plurality of hardware processing devices for execution of computer-readable program code instructions of selected machine learning models during runtime to support an operation of AI productivity tool-enablable software applications according to another embodiment of the present disclosure; and

FIG. 3 is a flow diagram showing a method of runtime switching between for execution of computer-readable program code instructions of selected machine learning models according to an embodiment of the present disclosure.

The use of the same reference symbols in different drawings may indicate similar or identical items.

### DETAILED DESCRIPTION OF THE DRAWINGS

The following description in combination with the Figures is provided to assist in understanding the teachings disclosed herein. The description is focused on specific implementations and embodiments of the teachings and is provided to assist in describing the teachings. This focus should not be interpreted as a limitation on the scope or applicability of the teachings.

Artificial intelligence (AI) is a developing technology that is used to increase efficiency of computing systems and humans alike. The information handling system of embodiments of the present disclosure may include AI productivity tools that interface with various AI productivity tool-enablable software applications that increase the efficiency of the operation of the information handling system. An example of AI technologies includes, but is not limited to, computer-readable program code instructions of an AI productivity tool such as for chat-enabled environments (voice, text, etc.). Often, these chat-enabled environments are described as AI productivity tool modules that receive this voice or text input from a user and implement a number of actions or responses based on the natural language of the input. In some information handling systems, the AI productivity tool modules may interface with computer-readable program code instructions of various AI productivity tool-enablable software applications being executed or executable on the information handling system having published or designated capabilities which may respond to an input query. These AI productivity tool-enablable software applications may integrate with the AI productivity tool to allow user queries to trigger certain actions declared, supported, and managed or conducted by these AI productivity tool-enablable software applications to provide responsive hardware or software operations in services, or a generate responses to the user input query. During execution of the computer-readable program code instructions of the ML model to interface with these AI productivity tool-enablable software applications, the hardware processor or hardware processing resource currently executing computer-readable program code instructions the ML model can lead to processing bottlenecks due to the processing resources required to execute both the ML model along with other processes for execution of software applications on the information handling system. This bottleneck is accentuated when other software applications such as gaming applications, computer-aided design applications, and the like are executed and require significant amounts of hardware processing resources.

The present specification describes a method of runtime switching between execution of code instructions among a selection of machine learning models algorithms in support of query-responsive operations of AI productivity tool-enablable software applications in an information handling system 100. The method may include, in an embodiment, executing computer-readable program code instructions of a software development kit (SDK) module with a hardware processor of an information handling system to initiate a request, on behalf of an AI productivity tool-enablable software application being executed on the information handling system, to an AI productivity tool software application for accessing a first machine learning (ML) model algorithm. In an embodiment, the SDK may include metadata with the request for the first ML model algorithm that describes the necessary type of ML model algorithm needed for the type of large language model to use such as, for example, LlaMA by Meta AI® or a Mistral AI® large language model, among others.

In an embodiment, the method includes executing computer-readable program code instructions of a swappable wrapper generator with the hardware processor to create a first wrapper around the first ML model algorithm. In an example embodiment, the wrapper may include any computer-readable program code that wraps an ML model algorithm to enable that ML model algorithm to be executed by a hardware processor of the information handling system in support of a responsive operation by the requesting AI productivity tool-enablable software application.

The method, in an embodiment, may include executing computer-readable program code instructions of an inference runtime control module to monitor the appropriateness or match of the runtime associated with the first ML model algorithm in support of a responsive operation by the requesting AI productivity tool-enablable software application. In an embodiment, the inference runtime controller may interface with the execution of a quality of service (QOS) metric detection module that detects metrics associated with the execution of the ML model algorithms at various different hardware processors as well as for executing processing tasks in support of a responsive operation by the requesting AI productivity tool-enablable software application on these hardware processing devices.

In an embodiment, the method includes executing computer-readable program code instructions of the inference runtime control module to select a second ML model algorithm to provide an alternative service to the query request of the first ML model algorithm, cause the swappable wrapper generator to create a second wrapper around the second ML model algorithm and release the first wrapper when the inference runtime control module determines that the runtime of the first ML model is not appropriate in support of a responsive operation by the requesting AI productivity tool-enablable software application and for the hardware processor device used.

In an embodiment, the method may allow for the hardware processor to execute computer-readable program code instructions of the inference runtime control module to switch from a first hardware processor executing the first ML model algorithm to a second hardware processor executing the first or a second ML model algorithm. This allows for the flexibility to seamlessly and transparently switch from a first hardware processor to a second hardware processor when the first hardware processor is experiencing high processing resource consumption and may not perform optimally while executing the first or second ML model algorithm that is selected. Still further, this allows the flexibility to seamlessly and transparently switch between a first ML model algorithm to a second ML model algorithm (e.g., Llama and Mistral) depending on the responsive operations to input queries by particular AI productivity tool-enablable software applications. In one embodiment, the execution of the inference runtime control module may switch from a first ML model algorithm maintained on the information handling system to a second ML model algorithm maintained on a server operatively coupled to the information handling system via a network connection.

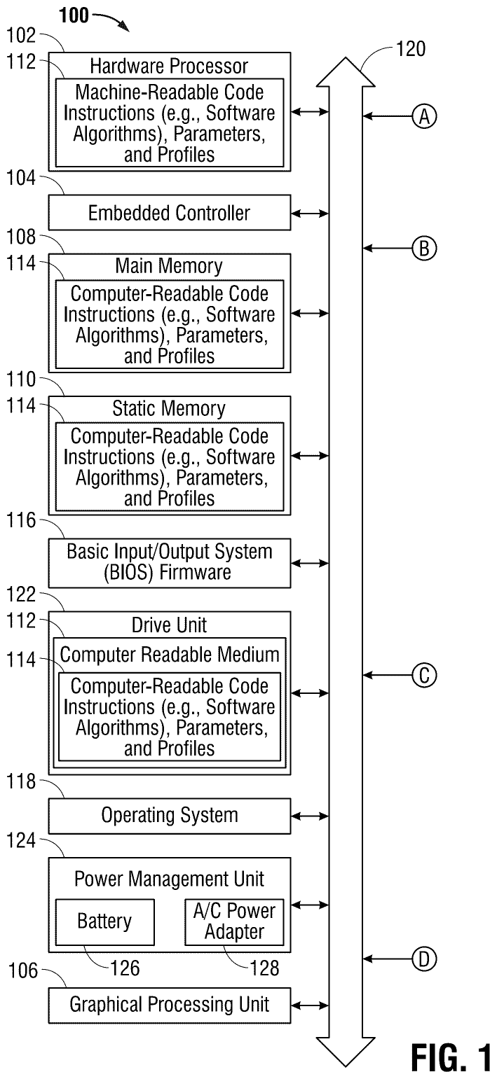

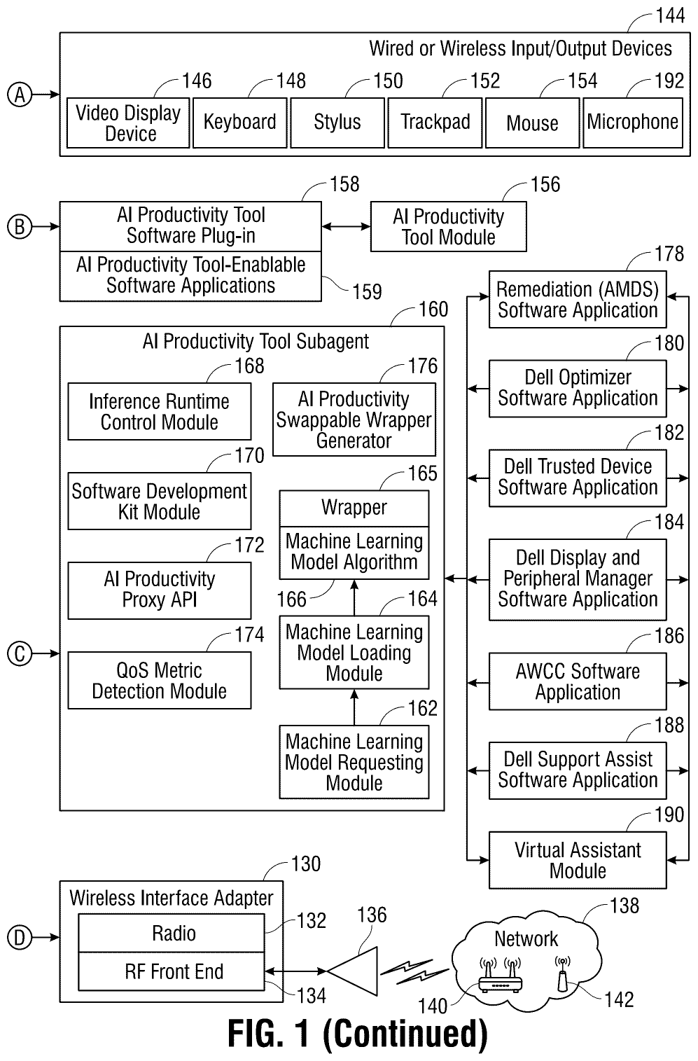

Turning now to the figures, FIG. 1 illustrates an information handling system 100 similar to the information handling systems according to several aspects of the present disclosure. In the embodiments described herein, an information handling system 100 includes any instrumentality or aggregate of instrumentalities operable to compute, classify, process, transmit, receive, retrieve, originate, switch, store, display, manifest, detect, record, reproduce, handle, or use any form of information, intelligence, or data for business, scientific, control, entertainment, or other purposes. For example, an information handling system 100 may be a personal computer, mobile device (e.g., personal digital assistant (PDA) or smart phone), server (e.g., blade server or rack server), a consumer electronic device, a network server or storage device, a network router, switch, or bridge, wireless router, or other network communication device, a network connected device (cellular telephone, tablet device, etc.), IoT computing device, wearable computing device, a set-top box (STB), a mobile information handling system, a palmtop computer, a laptop computer, a desktop computer, a communications device, an access point (AP) 140, a base station transceiver 142, a wireless telephone, a control system, a camera, a scanner, a printer, a personal trusted device, a web appliance, or any other suitable machine capable of executing a set of instructions (sequential or otherwise) that specify actions to be taken by that machine, and may vary in size, shape, performance, price, and functionality.

In a networked deployment, the information handling system 100 may operate in the capacity of a client computer in a server-client network environment, or as a peer computer system in a peer-to-peer (or distributed) network environment. In an embodiment, the information handling system 100 may be implemented using electronic devices that provide voice, video, or data communication. For example, an information handling system 100 may be any mobile or other computing device capable of executing a set of instructions (sequential or otherwise) that specify actions to be taken by that machine. Further, while a single information handling system 100 is illustrated, the term “system” shall also be taken to include any collection of systems or sub-systems that individually or jointly execute a set, or plural sets, of instructions to perform one or more computer functions.

The information handling system 100 may include main memory 108, (volatile (e.g., random-access memory, etc.), or static memory 110, nonvolatile (read-only memory, flash memory etc.) or any combination thereof), one or more hardware processing resources, such as a hardware processor 102 that may be a central processing unit (CPU), embedded controller (EC) 104, a graphics processing unit (GPU) 106, a neural processing unit (NPU), an accelerated processing unit (APU), other types of hardware processing devices, or any combination thereof. It is appreciated that the information handling system 100 may include any number of hardware processing devices described herein. Computer readable code instructions stored in main memory 108 (e.g., RAM) may be “hot” or quickly accessible by hardware processing resources using that main memory 108. Computer-readable program code instructions stored in static memory 110, main memory 108, or drive unit 122 may be “cold” and latency may be involved in invoking such computer-readable program code instructions to main memory 108 according to embodiments herein. Additional components of the information handling system 100 may include one or more storage devices such as static memory 110 or drive unit 122. The information handling system 100 may include or interface with one or more communications ports for communicating with external devices, as well as various input and output (I/O) devices 144, such as a mouse 154, a trackpad 152, a stylus 150, a keyboard 148, a video/graphics display device 146, a microphone 192, or any combination thereof. Portions of an information handling system 100 may themselves be considered information handling systems 100.

Information handling system 100 may include devices or modules that embody one or more of the devices or execute instructions for one or more systems and modules. The information handling system 100 may execute instructions (e.g., software algorithms), parameters, and profiles 114 that may operate on servers or systems, remote data centers, or on-box in individual client information handling systems according to various embodiments herein. In some embodiments, it is understood any or all portions of instructions (e.g., software algorithms), parameters, and profiles 114 may operate on a plurality of information handling systems 100.

The information handling system 100 may include the hardware processor 102 such as a central processing unit (CPU) or other hardware processing resources. Any of the hardware processing resources may operate to execute code that is either firmware or software code. Moreover, the information handling system 100 may include memory such as main memory 108, static memory 110, and disk drive unit 122 (volatile (e.g., random-access memory, etc.), nonvolatile memory (read-only memory, flash memory etc.) or any combination thereof or other memory with computer readable medium 112 storing instructions (e.g., software algorithms), parameters, and profiles 114 executable by the hardware processor 102 (e.g., central processing unit), NPU, APU, EC 104, GPU 106, or any other hardware processing device. The information handling system 100 may also include one or more buses 120 operable to transmit communications between the various hardware components such as any combination of various I/O devices 144 as well as between hardware processors 102, an EC 104, the operating system (OS) 118, the basic input/output system (BIOS) 116, the wireless interface adapter 130, or a radio module, among other components described herein. In an embodiment, the hardware processor 102, EC 104, GPU 106, NPU, APU, and/or others may execute one or more bus drivers in order to transmit this data between the information handling system 100 and the input/output devices 144 described herein. In an embodiment, the information handling system 100 may be in wired or wireless communication with the I/O devices 144 such a keyboard 148, a mouse 154, video display device 146, stylus 150, trackpad 152, microphone 192, among other peripheral devices.

As described herein, the information handling system 100 further includes a video/graphics display device 146. The video/graphics display device 146 in an embodiment may function as a liquid crystal display (LCD), an organic light emitting diode (OLED), a flat panel display, or a solid-state display. It is appreciated that the video/graphics display device 146 may be wired or wireless and may be an external video/graphics display device 146 that allows a user to increase the desktop area by extending the desktop in an embodiment. Additionally, as described herein, the information handling system 100 may include or be operatively coupled to a cursor control device (e.g., a trackpad 152, or gesture or touch screen input), a stylus 150, and/or a keyboard 148, among others that allows the user to interface with the information handling system 100 via the video/graphics display device 146. Information handling system 100 may also be operatively coupled to a wired or wireless input/output device 144 or other hardware devices that may include a hardware processing device such as a hardware processor, microcontroller, or other hardware processing resource. Various drivers and hardware control device electronics may be operatively coupled to operate the I/O devices 144 according to the embodiments described herein. The present specification contemplates that the I/O devices 144 may be wired or wireless.

A network interface device of the information handling system 100 may be wired or wireless such as shown with wireless interface adapter 130 that can provide wireless connectivity among devices such as with Bluetooth® or to a network 138, e.g., a wide area network (WAN), a local area network (LAN), wireless local area network (WLAN), a wireless personal area network (WPAN), a wireless wide area network (WWAN), or other network. In embodiments described herein, the wireless interface device 130 with its radio 132, RF front end 134 and antenna 136 is used to communicate with the wireless peripheral devices, via, for example, a Bluetooth® or Bluetooth® Low Energy (BLE) protocols or any proprietary RF protocol such as those may utilize similar frequency ranges but proprietary modulation and data transmission characteristics. In embodiments, Bluetooth®, BLE, proprietary RF protocol, or other WPAN or WLAN protocols and plural such protocols may be used for communication with and among any wireless peripheral device to be paired or paired with the information handling system 100 or other information handling systems.

In other embodiments, a WAN, WWAN, LAN, and WLAN may each include an AP 140 or base station 142 used to operatively couple the information handling system 100 to a network 138 via a wireless interface adapter 130. In a specific embodiment, the network 138 may include macro-cellular connections via one or more base stations 142 or a wireless AP 140 (e.g., Wi-Fi), or such as through licensed or unlicensed WWAN small cell base stations 142. Connectivity may be via wired or wireless connection. For example, wireless network wireless APs 140 or base stations 142 may be operatively connected to the information handling system 100. Wireless interface adapter 130 may include one or more RF (RF) subsystems (e.g., radio 132) with transmitter/receiver circuitry, modem circuitry, one or more antenna RF (RF) front end circuits 134, one or more wireless controller circuits, amplifiers, antennas 136 and other circuitry of the radio 132 such as one or more antenna ports used for wireless communications via multiple radio access technologies (RATs). The radio 132 may communicate with one or more wireless technology protocols.

In an embodiment, the wireless interface adapter 130 may operate in accordance with any wireless data communication standards. To communicate with a wireless local area network, standards including IEEE 802.11 WLAN standards (e.g., IEEE 802.11ax-2021 (Wi-Fi 6E, 6 GHZ)), IEEE 802.15 WPAN standards, WWAN such as 3GPP or 3GPP2, Bluetooth® standards, proprietary RF protocol, or similar wireless standards may be used. Wireless interface adapter 130 may connect to any combination of macro-cellular wireless connections including 2G, 2.5G, 3G, 4G, 5G or the like from one or more service providers. Utilization of RF communication bands according to several example embodiments of the present disclosure may include bands used with the WLAN standards and WWAN carriers which may operate in both licensed and unlicensed spectrums. The wireless interface adapter 130 can represent an add-in card, wireless network interface module that is integrated with a main board of the information handling system 100 or integrated with another wireless network interface capability, or any combination thereof.

In some embodiments, a hardware processing resource executes computer-readable program code instructions of software or firmware to implement one or more of some systems and methods described herein, or dedicated hardware implementations such as application specific integrated circuits, programmable logic arrays and other hardware devices may be constructed to implement one or more of some systems and methods described herein. Applications that may include the apparatus and systems of various embodiments may broadly include a variety of electronic and computer systems. One or more embodiments described herein may implement functions using two or more specific interconnected hardware devices with related control and data signals that may be communicated between and through the modules, or as portions of an application-specific integrated circuit. Accordingly, the present system encompasses a hardware processing resource executing computer-readable program code instructions of software or firmware as well as hardware implementations or any combination.

In accordance with various embodiments of the present disclosure, the methods described herein may be implemented by firmware or software programs executable by a hardware controller or a hardware processor system. Further, in an exemplary, non-limited embodiment, implementations may include distributed hardware processing, component/object distributed hardware processing, and parallel hardware processing. Alternatively, virtual computer system processing may be constructed to implement one or more of the methods or functionalities as described herein.

The present disclosure contemplates a computer-readable medium that includes computer-readable program code instructions, parameters, and profiles 114 or receives and executes computer-readable program code instructions, parameters, and profiles 114 responsive to a propagated signal, so that a hardware device connected to a network 138 may communicate voice, video, or data over the network 138. Further, the computer-readable program code instructions, parameters, and profiles 114 may be transmitted or received over the network 138 via the network interface device or wireless interface adapter 130.

The information handling system 100 may include a set of computer-readable program code instructions, parameters, and profiles 114 that may be executed to cause the computer system to perform any one or more of the methods or computer-based functions disclosed herein. For example, computer-readable program code instructions, parameters, and profiles 114 may be executed by a hardware processor 102, GPU 106, EC 104 or any other hardware processing resource and may include software agents, or other aspects or components used to execute the methods and systems described herein. Various software modules comprising application computer-readable program code instructions, parameters, and profiles 114 may be coordinated by an OS 118, and/or via an application programming interface (API) include a unified device API described herein. An example OS 118 may include Windows®, Android®, and other OS types. Example APIs may include Win 32, Core Java API, or Android APIs.

In an embodiment, the information handling system 100 may include a disk drive unit 122. The disk drive unit 122 and may include machine-readable program code instructions, parameters, and profiles 114 in which one or more sets of machine-readable program code instructions, parameters, and profiles 114 such as firmware or software can be embedded to be executed by the hardware processor 102 (e.g., CPU) or other hardware processing devices such as a GPU 106, an EC 104, an NPU, an APU, or other hardware processing resource device to perform the processes described herein. Similarly, main memory 108 and static memory 110 may also contain a computer-readable medium for storage of one or more sets of machine-readable program code instructions, parameters, or profiles 114 described herein. The disk drive unit 122 or static memory 110 also contain space for data storage. Further, the machine-readable program code instructions, parameters, and profiles 114 may embody one or more of the methods as described herein. In a particular embodiment, the machine-readable program code instructions, parameters, and profiles 114 may reside completely, or at least partially, within the main memory 108, the static memory 110, and/or within the disk drive 122 during execution by the hardware processor 102, EC 104, or GPU 106 of information handling system 100.

Main memory 108 or other memory of the embodiments described herein may contain computer-readable medium (not shown), such as RAM in an example embodiment. An example of main memory 108 includes random access memory (RAM) such as static RAM (SRAM), dynamic RAM (DRAM), non-volatile RAM (NV-RAM), or the like, read only memory (ROM), another type of memory, or a combination thereof. Static memory 110 may contain computer-readable medium (not shown), such as NOR or NAND flash memory in some example embodiments. The applications and associated APIs, for example, may be stored in static memory 110 or on the disk drive unit 122 that may include access to a machine-readable code instructions, parameters, and profiles 114 such as a magnetic disk or flash memory in an example embodiment. While the computer-readable medium is shown to be a single medium, the term “computer-readable medium” includes a single medium or multiple media, such as a centralized or distributed database, and/or associated caches and servers that store one or more sets of machine-readable code instructions. The term “computer-readable medium” shall also include any medium that is capable of storing, encoding, or carrying a set of machine-readable code instructions for execution by a processor or that cause a computer system to perform any one or more of the methods or operations disclosed herein.

In an embodiment, the information handling system 100 may further include a power management unit (PMU) 124 (a.k.a. a power supply unit (PSU)). The PMU 124 may include a hardware controller and executable machine-readable code instructions to manage the power provided to the components of the information handling system 100 such as the hardware processor 102 and other hardware components described herein. The PMU 124 may control power to one or more components including the one or more drive units 122, the hardware processor 102 (e.g., CPU), the EC 104, the GPU 106, a video/graphic display device 146, or other wired I/O devices 144 such as the mouse 154, the stylus 150, the keyboard 148, and the trackpad 152 and other components that may require power when a power button has been actuated by a user. In an embodiment, the PMU 124 may monitor power levels and be electrically coupled to the information handling system 100 to provide this power. The PMU 124 may be coupled to the bus 120 to provide or receive data or machine-readable code instructions. The PMU 124 may regulate power from a power source such as the battery 126 or AC power adapter 128. In an embodiment, the battery 126 may be charged via the AC power adapter 128 and provide power to the components of the information handling system 100, via wired connections as applicable, or when AC power from the AC power adapter 128 is removed.

In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to store information received via carrier wave signals such as a signal communicated over a transmission medium. Furthermore, a computer readable medium 110 can store information received from distributed network resources such as from a cloud-based environment. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or machine-readable code instructions may be stored.

In other embodiments, dedicated hardware implementations such as application specific integrated circuits (ASICs), programmable logic arrays and other hardware devices can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses hardware resources executing software or firmware, as well as hardware implementations.

As described in embodiments herein, the information handling system 100 includes an AI productivity tool module 156 and an AI productivity tool subagent 160 working with the AI productivity tool module software 156 to select among a plurality of AI productivity tool-enablable software applications 159 according to another embodiment of the present disclosure. As described herein, computer readable code instructions of the AI productivity tool module 156 and AI productivity tool subagent 160 may be executed by a hardware processor 102 on the information handling system 100 thereby allowing the methods described herein to be carried out on-the-box such that a wired or wireless network connection to a network is not necessary for operation of the method. In another embodiment, some modules, databases, and/or processing resources may be maintained on a remote server such that a wired or wireless network connection can be made with these remote servers and the method may be implemented as described herein.

The AI productivity tool module 156 may include any artificial intelligence-based productivity tool to assist in interface and execution of one or more AI productivity tool-enablable software applications 159 for query inputs from a user of an information handling system 100 and responsive actions, software services, or other responses from the information handling system 100. The AI productivity tool module 156 may include chatbot features, virtual assistant features, and other artificial intelligence features that allow a user to provide input to the information handling system 100 and, with generative artificial intelligence processing execute one or more capabilities that include operations, functions, software services, or responses using one or more AI productivity tool-enablable software applications 159. Examples of some AI productivity tool modules 156 may include Cortana® by Microsoft®, Copilot® by Microsoft®, Siri® by Apple® Inc., Gemini® by Google AIR, ChatGPT® by OpenAI®, and Amazon Alexa® by Amazon®, among others. It is appreciated that the information handling system 100 may include any proprietary AI productivity tool module 156 used to interface with the information handling system 100 and the operations thereon. In various embodiments, the hardware processor 102 or other alternative hardware processing resources of the information handling system 100 may execute computer-readable program code instructions of the AI productivity tool module 156 with its AI productivity tool plug-in 158 and monitor for user input at a microphone 192, keyboard 148, or other input device for the AI productivity tool module 156 to engage in AI productivity actions pursuant to the user input.

The AI productivity tool module 156, executing on the hardware processor 102 or other hardware processing resource (e.g., EC 104, GPU 106, APU, or NPU), may interface with other hardware components and with the AI productivity tool-enablable software applications 159 and one or more ML module algorithms 166 of the information handling system 100 (e.g., via a bus 120) via an AI productivity tool plug-in 158. The AI productivity tool plug-in 158 may be any software or firmware that allows the AI productivity tool module 156 to perform those actions at the information handling system 100 based on input (e.g., typed or spoken words) from the user. The AI productivity tool plug-in 158 may be used by the AI productivity tool module 156 to interface with any number of AI productivity tool-enablable software applications 159 executing or executable on the information handling system 100.

The information handling system 100 also includes an AI productivity tool software application 160. The AI productivity tool software application 160 may be any software and/or firmware executable by the hardware processor 102 of the information handling system 100 to interface one or more of a plurality of the AI productivity tool-enablable software applications 159 (such as a remediation (AMDS) software application 178, Dell® Optimizer® software application 180, Dell® Trusted Device® software application 182, Dell® Display and Peripheral Manager® software application 184, Alienware® Command Center (AWCC) software application 186, Dell® Support Assist® software application 188, virtual assistant module 190) to provide AI enabled capabilities within those AI productivity tool-enablable software applications (e.g., 178, 180, 182, 184, 186, 188, 190) for responsive operations, functions, software services, or response to user input queries. In an embodiment, the computer-readable program code instructions of the software applications (e.g., AI productivity tool-enablable software applications 159) and modules described herein (e.g., 178, 180, 182, 184, 186, 188, 190) may operate wholly “on-box” within the information handling system 100 or be sub-agents on-box for interfacing with remote software systems executing at remote server locations. In an embodiment, the AI productivity tool software application 160 may be used to direct the execution of various modules in support of the AI productivity tool-enablable software applications 159 described herein. Additionally, the AI productivity tool software application 160 may be provided with access to the BIOS and OS of the information handling system 100 to conduct the AI productivity actions pursuant to the user's input provided at the AI productivity tool module 156. Examples of AI productivity tool-enablable software applications 159 may include, for example, Dell® Trusted Device® software application 182, a remediation Dell® APEX Managed Device Service (AMDS)® software application 178, AWCC software application 186, Dell® Optimizer® software application 180, Dell® Display and Peripheral Manager software application 184, and a virtual assistant module 190, among others.

In an embodiment, the hardware processor 102 or other hardware processing resource (e.g., EC 104, GPU 106, APU, or NPU) executing computer-readable program code instructions of the AI productivity tool software application 160 may include a machine learning model requesting module 162. A hardware processor executing code instructions of the machine learning model requesting module 162 may be used by the AI productivity tool subagent 160 to, when prompted via the AI productivity tool plug-in 158, fulfill a “contract” for the provision of an ML model algorithm 166 by requesting a specific machine learning (ML) model algorithm 166 that is designated to support execution of capabilities or operations of the AI productivity tool module 156 in receiving an input query or one or more AI productivity tool-enablable software applications 159 in response.

The “contract” described herein defines the requirements that a selected ML model algorithm is to have in order to be able receive a specific type of input from the AI productivity tool-enablable software application or AI productivity tool subagent and to provide a specific type of output to the AI productivity tool-enablable software application 159 or AI productivity tool subagent 160. For example, a contact may include data that describes that audio data is to be used as input and, as output, text is to be received from the selected ML model algorithm 166. This defines, therefore, that the ML model algorithm 166 must be capable of completing speech-to-text conversions with the audio data received from, for example, a microphone 192 and further defines that the ML model algorithm 166 must provide output in the form of text. It is appreciated that a plurality of ML model algorithms 166 may perform some, all, or more functionalities required per the contract. For example, a first ML model algorithm 166 may perform only a speech-to-text function while a second ML model algorithm 166 may perform the speech-to-text function along with a natural language summarizing task. In this example, the second ML model 166 may provide features that may not be necessary for a simple speech-to-text process as in the first ML model algorithm 166. However, because both the first and the second ML model algorithms 166 perform a speech-to-text function, they may be said to have a common contract between them even though the second ML model algorithm 166 also has a feature that summarizes text (e.g., the natural language summarizing task). In some situations where only speech-to-text conversion is required, both the first ML model algorithm 166 and the second ML model algorithm 166 could be selected for invocation on behalf of an executing AI productivity tool-enablable software application 159 and/or AI productivity tool subagent 160. Thus, executing computer-readable program code instructions of the inference runtime control module may select a second ML model algorithm to provide an alternative service to the request of the first ML model algorithm by the AI productivity tool-enablable software application based on a common contract between the first ML model algorithm and the second ML model algorithm. The processing resources used to execute the second ML model algorithm 166, however, may be significantly less than those processing resources required in order to execute the first ML model algorithm 166, or vice-versa. The systems and methods described herein may allow the information handling system 100 to monitor for these differences in processing resource consumption and make adjustments to selection of the ML model algorithm 166 used and/or the hardware processor (e.g., CPU, EPU, NPU, EC, etc.) being used to execute the ML model algorithm 166 as described herein in order to provide a level of quality of service to the user of the information handling system 100.

During operation for example, the machine learning model requesting module 162 may request that one or more machine learning model algorithms 166 be loaded by the machine learning model loading module 164 such that, for example, the voice input from the user may be processed through a speech recognition model and then text from speech or directly entered may then be processed through a natural language model in order to determine an intent value of the user's input. It is appreciated that these machine learning model algorithms 166 may include one or more models that work together to both decipher the user's intent to a query intent value defined according to the ML model algorithm 166 while also conducting operations at the information handling system 100 to provide feedback to the user such as creating AI generated text at a word processing application or for an audio system being executed by the hardware processor 102 on the information handling system 100, for example.

In an embodiment, hardware processor 102 executing computer-readable program code instructions of the AI productivity tool software application 160 also includes a software development kit (SDK) module 170. The SDK module 170 may include any computer-readable program code instructions that is executed by the hardware processor to request that a machine learning model algorithm 166 be provided during the execution of an AI productivity tool-enablable software application 159 to support a determination of capabilities and executing those capabilities in response to a user input query. For example, where a user interacts with the graphical user interface (GUI) of an AI productivity tool-enablable software application 159 being executed on the video display device 146 and selects an AI productivity tool be used, the SDK module 170 then requests from the AI productivity tool subagent 160 a specific ML model algorithm 166 to be loaded and executed on a first hardware processing device of the information handling system. The selection by the user of the AI productivity tool within the AI productivity tool-enablable software application 159, therefor, sets off a process by which a specific ML model algorithm 166 is loaded to RAM 108 beforehand or maintained in RAM 108 and then executed in order to provide to the user the ability to provide input via voice, text, or other at the information handling system 100 in order to receive AI generated output. In a specific example, the user may be drafting a lengthy document or email and may select a speech-to-text AI productivity tool available within the word processing application or email application (e.g., both examples of an AI productivity tool-enablable software application 159). The selection of this speech-to-text AI productivity tool causes the AI productivity tool subagent 160 to execute the SDK module 170 in order to begin the process of communicating this request to a machine learning model requesting module 162 for handling of that request. In an embodiment, the SDK module 170 may present the request for the ML model algorithm 166 such that a specific type of ML model algorithm 166 that can perform the task of receiving speech audio input and converting it to text for incorporation into the document or email of one of the AI productivity tool-enablable software applications 159 is executed on the information handling system 100 at the hardware processing device (e.g., hardware processor 102, EC 104, GPU 106, NPU, APU, etc.).

In an embodiment, the AI productivity tool subagent 160 may initially validate the request for the execution of the ML model algorithm 166. This validation process may include, for example, determining whether a specific ML model algorithm 166 or a specific type of ML model algorithm 166 that satisfies the request is available to the information handling system 100. In an example embodiment, the ML model algorithms 166 available at the information handling system 100 may be stored on a memory device (e.g., static memory 110 such as a solid-state drive (SSD) or main memory 108) and accessible to the AI productivity tool subagent 160. In another example embodiment, the information handling system 100 may be operatively coupled to a server on the network 138 that maintains these ML model algorithms 166. In either of these examples, however, the certain ML model algorithm 166 or type of ML model algorithm 166 may not be available the AI productivity tool subagent 160. Thus, the validation process during the execution of the computer-readable program code instructions of the AI productivity tool module 160 may initially determine the availability of these ML model algorithms 166 and available location prior to proceeding.

In an embodiment, the request by the SDK module 170 may cause the hardware processor 102 to execute computer-readable program code instructions of an AI productivity proxy application programming interface (API) 172 to handle the request for a specific ML model algorithm 166 based on an interface contract defining a specific ML model algorithm 166 such as to be used with an AI productivity tool-enablable software applications 159 or with a specific capability of one of the AI productivity tool-enablable software applications 159. This interface contract, again, describes the available inputs into the ML model algorithm 166 and the provided outputs from the ML model algorithm 166 that will satisfy the AI productivity tool-enablable software application 159 requirements to perform a capability for an operation, function, software service or response that is responsive to a user input query. This description of the available inputs and outputs associated with the ML model algorithm 166 may be presented as metadata during the request by the AI productivity proxy API 172. For example, a request for a speech-to-text ML model algorithm 166 requires the AI productivity proxy API 172 to screen for and find an ML model algorithm 166 that receives, as input, an audio input (e.g., via microphone 192) and provides, as output, alphanumeric output that transforms spoken words into text. Therefore, the AI productivity proxy API 172 is used to interface (e.g., send inputs to and receive outputs from) the AI productivity tool-enablable software application 159 with the selected ML model algorithm 166.

In an embodiment, the hardware processor 102 executing computer-readable program code instructions of the AI productivity tool subagent 160 also includes an AI productivity swappable wrapper generator 176. The execution of the computer-readable program code instructions of the AI productivity swappable wrapper generator 176 causes a wrapper 165 to be created around the chosen ML model algorithm 166 used to service the request by the AI productivity proxy API 172 on behalf of the AI productivity tool-enablable software application 159. In the present specification and in the appended claims, the term “wrapper” or “ML model wrapper” is meant to be understood as any machine learning software shell that enables a hardware processor to access the underlying ML model algorithm for execution on behalf of an AI productivity tool-enable software application and/or AI productivity tool subagent. This wrapper 165 may be used to wrap a chosen ML model algorithm 166 thereby enabling the ML model algorithms 166 to be run by a hardware processing device at the operating system level and run in the background or switched between hardware processing devices seamlessly when one particular hardware processing device is detected as reaching resource limits (e.g., reaching or exceeding a processing resource threshold) or the like. The wrapper 165, also referred to as an ML model wrapper, generates as a shell for the ML model algorithm 166 to provide a switchable OS level inference runtime library with selection of inputs usable with the ML model algorithm 166 to control when and how a hardware processor, such as 102, may interface with the ML model algorithm 166. In this way, seamless switching among hardware processors in a chipset having plural hardware processors may be used to run the underlying ML model algorithm 166.

When the ML model wrapper 165 has been generated, the AI productivity tool software application 160 may return a handle of the ML model wrapper 165 to the SDK module 170 which returns the AI productivity proxy API 172 that includes the interface contract and handle to the AI productivity tool-enablable software application 159 for use in running the ML model algorithm 166 or by any hardware processor within the chipset of the information handling system 100. The AI productivity tool-enablable software application 159 beings to use the ML model algorithm 166 for the AI productivity tool-enablable software application 159 to submit inputs into and receive outputs from the execution of the ML model algorithm 166. In an embodiment, the AI productivity tool subagent 160 may determine first whether or not the AI productivity tool-enablable software application 159 is needing the ML model algorithm 166 and which ML model algorithm 166 is appropriate to meet the contract for needs of the AI productivity tool 156 or an AI productivity tool-enablable software application 159. The “appropriateness” of a ML model algorithm 166 for use by the AI productivity tool-enablable software application or AI productivity tool subagent may depend, at least, on the contract to be fulfilled as described herein, the hardware processing resources available, the current QoS detected by the execution of the computer-readable program code of the QoS metric detection module 174, along with whether the contract has changed since the last invoking the ML model algorithm 166. Additionally, in an embodiment, the AI productivity tool subagent 160 may determine if a hardware processor currently executing an ML model algorithm 166 is reaching or exceeding processing resource limits and should be switched to avoid degradation of performance of the information handling system.

In an embodiment, where the AI productivity tool-enablable software application 159 does need a particular, appropriate ML model algorithm 166 that is available, the hardware processor may execute computer-readable program code of an inference runtime control module 168 to monitor operation of the ML model algorithm 166 or the effect on a hardware processor executing the same. The execution of the inference runtime control module 168 may initially determine whether the hardware processor 102 currently executing the computer-readable program code instructions of the current ML model algorithm 166 runtime is reaching a hardware processor resource utilization maximum threshold based on current processing conditions of the hardware processor executing the ML model algorithm 166 at the information handling system 100. In an embodiment where the inference runtime control module 168 determines that the current runtime of the ML model algorithm 166 causing a hardware processor being used to reach threshold limits of resource utilization, the inference runtime control module 168 may choose a new hardware processor to execute the ML model algorithm 166. In an embodiment, the new, alternate hardware processor may be another hardware processing resource device within the information handling system. In other embodiments, the processor of a server located remotely from the information handling system 100 and accessed by the information handling system 100 via the wired or wireless connection to the network 138 as described herein may be an alternate hardware processor. In such embodiments, the inference runtime control module 168 may select that the inputs be provided to another onboard hardware processor (GPU 106, APU, NPU, etc.) or to the server and processed by the alternate hardware processor selected, as well as receive outputs from the alternat hardware processor or the server thereby relying on hardware processing resources available to the information handling system 100 and reducing the load on the previously operating hardware processing resource that was executing the ML model algorithm 166.

In another embodiment, a hardware processor executes computer-readable program code instructions of the inference runtime control module 168 to invoke the AI productivity swappable wrapper generator 176 to swap between a first ML model algorithm 166 to a second ML model algorithm 166 if an ML model algorithm 166 being invoked is not appropriate for use with a AI productivity tool-enablable software applications 159. In some embodiments, during this switch of ML model algorithms 166, a switch between hardware processing devices executing the ML model algorithms 166 may also occur if appropriate. For example, certain types of processing resources such as an APU or an NPU may be better suited than a CPU to execute an ML model algorithm 166. In such an embodiment, switching between hardware processors may include switching between a first hardware processor (e.g., hardware processor 102) on the information handling system 100 to a second hardware processor (e.g., the GPU 106, an APU, an NPU, etc.) also on the information handling system 100 and a wrapper 165 generated to provide a shell for directing inputs and outputs to the ML model algorithm 166 to be executed, such as the ML model algorithm being switched to. In another embodiment, switching between hardware processors may include switching between a first hardware processor (e.g., hardware processor 102) on the information handling system 100 to a second hardware processor (e.g., the GPU 106, an APU, an NPU, etc.) on a remote server wired or wirelessly coupled to the information handling system 100. In an example embodiment where the hardware processing device executing the ML model algorithm 166 is switched from a hardware processing device at the information handling system 100 to a hardware processing device or resource on a remote server accessible via the network 138, the AI productivity swappable wrapper generator 176 may unwrap the first ML model algorithm 166 and wrap a second ML model algorithm 166 being stored.

In an embodiment, the wrapper 165 allows an alternative hardware processor to seamlessly switch from the first ML model algorithm 166 to the second ML model algorithm 166. In an embodiment where the switching between hardware processors may include switching between a first hardware processor (e.g., hardware processor 102) on the information handling system 100 to a second hardware processor (e.g., the GPU 106, an APU, an NPU, etc.) also on the information handling system 100, the AI productivity swappable wrapper generator 176 may unwrap the first ML model algorithm 166 and wrap a second ML model algorithm 166 being stored on a memory device such as a SSD on the information handling system. This is done so that the AI productivity proxy API 172 can communicate the inputs and outputs to and from an ML model algorithm 166. The hardware processor (e.g., 102, 104, NPU, APU) and the AI productivity tool-enablable software applications 159, in this example embodiment, therefore, execute and engage the inference runtime control module 168 to orchestrate the switching of hardware processors, transparently to the user, during runtime. In some embodiments, the inference runtime control module 168 may also orchestrate the switching from one or a first ML model algorithm 166 to another or a second ML model algorithm 166. This ensures and ML model algorithm 166 that is appropriate for the operation of the AI productivity tool-enablable software applications 159 is loaded to main memory 108 from a cold memory storage such as a static memory device 110 or a drive unity 122 for faster access upon switching from a first ML model algorithm 166 to a second ML model algorithm 166.

During operation in an example embodiment, the inference runtime control module 168 may interface with a quality of service (QOS) metric detection module 174. The hardware processor 102 may execute computer readable code instructions of a QoS metric detection module 174 used to monitor and detect QoS metrics at the information handling system 100 and provide these QoS metrics to the inference runtime control module 168. In an embodiment, these QoS metrics may include consumption metrics describing processing resources at each of the hardware processing devices (e.g., hardware processor 102, EC 104, GPU 106, a microcontroller, an APU, an NPU, etc.), application types being executed on the hardware processing devices, and other QoS metrics that effect the user experience of the information handling system 100. These QoS metrics may be used to determine if and when the hardware processor resource levels reach a maximum or threshold level when an ML model algorithm 166 selected for a particular task or capability is being executed by any particular hardware processing resource on behalf of an AI productivity tool-enablable software application 159. It is appreciated that QoS threshold metrics may be implemented by the inference runtime control module 168 such that when a QoS threshold is reached or exceeded, the inference runtime control module 168 may proceed to switch from a first hardware processing device to second hardware processing device based on these QoS metrics detected by the QoS metric detection module 174 according to embodiments described herein.

Additionally, it is appreciated that that QoS threshold metrics may be implemented by the inference runtime control module 168 such that when a QoS threshold is reached or exceeded, the inference runtime control module 168 may proceed to switch from a first ML model algorithm 166 to a second ML model algorithm 166 based on these QoS metrics detected by the QoS metric detection module 174. For example, where the execution of the first ML model algorithm 166 causes the processing resources of any given hardware processor to reach a maximum or a threshold level based on the QoS metrics, a second ML model algorithm 166 may be selected that may provide similar or same ML capabilities as the first ML model algorithm 166 but with less processing requirements. This may be true where the first ML model 166 includes a combination or group of cooperating ML model algorithms 166 that initially provided relatively more capabilities for the AI productivity tool-enablable software application 159, but now include some capabilities that are no longer needed to provide the necessary output to the AI productivity tool-enablable software application 159. For example, the first ML model algorithm 166 may include a combination of a speech recognition ML model algorithm 166, a speech-to-text ML model algorithm 166, and an intent detection ML model algorithm 166. Where an initial audio input from the user via a microphone 192 is provided, the execution of the AI productivity tool-enablable software application 159 may initially provide, as input, this audio data to the combination ML model algorithm 166. However, the user may not be required to continuously provide audio input to the microphone 192 in order to receive output from the ML model algorithm 166. For example, a user may switch to text input instead. Thus, the execution of the first ML model algorithm 166 may be switched to a second ML model algorithm 166 that does not have a speech recognition and speech to text capability within the ML model algorithm 166 thereby reducing the processing requirements during execution of this second ML model algorithm 166. Therefore, the execution of the computer-readable program code instructions of the inference runtime control module 168 may allow for either or both of the switching between hardware processors and ML models based on QoS metrics detected by the QoS metric detection module 174.

The systems and methods described herein allow for the hardware processor 102 executing computer-readable program code instructions an inference runtime control module 168 to orchestrate the dynamic and seamless switching of ML model algorithms 166 that support an interface contract with the AI productivity tool-enablable software applications 159 being executed on the information handling system 100 by a hardware processing device to respond to input queries received from a user. The AI productivity proxy API 172 allows for the identification and request process for these various ML model algorithms 166 while the AI productivity swappable wrapper generator 176 may, under the direction of the inference runtime control module 168, utilize a ML model wrapper 165 to provide seamless switching to inputs for an ML model algorithm or swap a wrapper 165 from a first ML model algorithm 166 to a second ML model algorithm 166 where needed.

When referred to as a “system,” a “device,” a “module,” a “controller,” or the like, the embodiments described herein can be configured as hardware. For example, a portion of an information handling system device may be hardware such as, for example, an integrated circuit (such as an Application Specific Integrated Circuit (ASIC), a Field Programmable Gate Array (FPGA), a structured ASIC, or a device embedded on a larger chip), a card (such as a Peripheral Component Interface (PCI) card, a PCI-express card, a Personal Computer Memory Card International Association (PCMCIA) card, or other such expansion card), or a system (such as a motherboard, a system-on-a-chip (SoC), or a stand-alone device). The system, device, controller, or module can include hardware processing resources executing software, including firmware embedded at a device, such as an Intel® brand processor, AMD® brand processors, Qualcomm® brand processors, or other processors and chipsets, or other such hardware device capable of operating a relevant software environment of the information handling system. The system, device, controller, or module can also include a combination of the foregoing examples of hardware or hardware executing software or firmware. Note that an information handling system can include an integrated circuit or a board-level product having portions thereof that can also be any combination of hardware and hardware executing software. Devices, modules, hardware resources, or hardware controllers that are in communication with one another need not be in continuous communication with each other, unless expressly specified otherwise. In addition, devices, modules, hardware resources, and hardware controllers that are in communication with one another can communicate directly or indirectly through one or more intermediaries.

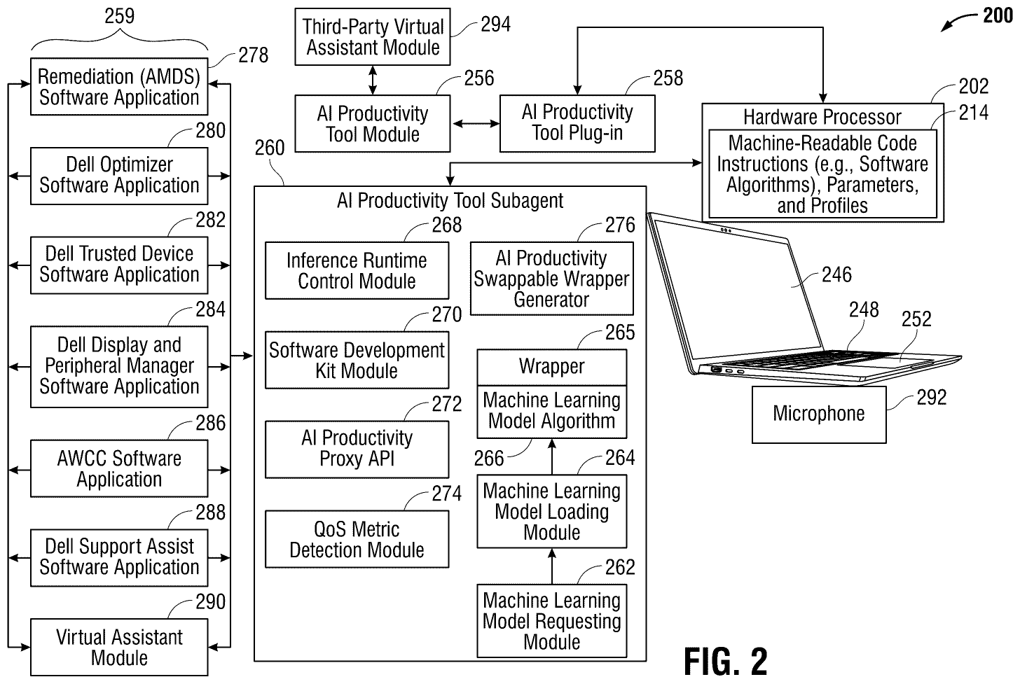

FIG. 2 is a graphic and block diagram illustrating an information handling system that includes computer-readable program code instructions an AI productivity tool module 256 and an AI productivity tool subagent 260 to switch among a plurality of hardware processing devices and/or ML model algorithms 266 during runtime according to another embodiment of the present disclosure. As described herein, the AI productivity tool module 256 and AI productivity tool subagent 260 may be executed by a hardware processor 202 on the information handling system 200 thereby allowing the methods described herein to be carried out on-the-box or with access, via a wired or wireless connection, to a server maintained on a network. In embodiments, some modules, databases, and/or processing resources may be maintained on a remote server such that a wired or wireless connection can be made with these remote servers and the method may be implemented as described herein.

In FIG. 2, the information handling system 200 is shown as a laptop-type information handling system 200. However, the present specification contemplates that the information handling system 200 may be any type of information handling system as described herein. The information handling system 200 in FIG. 2 includes a video display device 246 used to provide output to the user. The information handling system 200 further includes a keyboard 248 and a trackpad 252 used by the user to provide input to the information handling system 200. It is appreciated that this input from the user may be received from the user using any device including the microphone 292, the trackpad 252, and the keyboard 246. In the example embodiments described herein, a virtual assistant module 290 or a third-party virtual assistant module 294 may be used to receive this input on behalf of the AI productivity tool-enablable software application 259 and the AI productivity tool module 256.

As described in embodiments herein, the information handling system 200 includes an AI productivity tool module 256 and an AI productivity tool subagent 260 to select among a plurality of AI productivity tool-enablable applications 259 according to another embodiment of the present disclosure. As described herein, the AI productivity tool module 256 and AI productivity tool subagent 260 may be executed by a hardware processor 202 on the information handling system 200 thereby allowing the methods described herein to be carried out on-the-box such that a wireless connection to a network is not necessary for operation of the method. In another embodiment, some modules, databases, and/or processing resources may be maintained on a remote server such that a wireless connection can be made with these remote servers and the method may be implemented as described herein.

The AI productivity tool module 256 may include any artificial intelligence-based productivity tool. Examples of some AI productivity tool modules 256 may include Cortana® by Microsoft®, Copilot® by Microsoft®, Siri® by Apple® Inc., Gemini® by Google AI®, ChatGPT® by OpenAI®, and Amazon Alexa® by Amazon®, among others. The AI productivity tool module 256 may include chatbot features, virtual assistant features, and other artificial intelligence features that allow a user to provide input such as audio input data, text input data, image input data, or other query input to the information handling system 200 and, with generative artificial intelligence processing, determine an input intent value. According to embodiments of the present disclosure, the information handling system 200 may include any proprietary AI productivity tool module 256 used to interface with the information handling system 200 and the operations thereon. In an embodiment, the hardware processor 202 of the information handling system 200 may execute computer-readable program code instructions of the AI productivity tool module 256 with its AI productivity tool plug-in 258 and monitor for user input at a microphone 292, keyboard 248, or other input device for the AI productivity tool module 256 to determine a query input intent value and correlate that query intent value to a capability intent value to engage in AI productivity actions to determine a user query input or a response pursuant to the user query input by capabilities for the AI productivity tool module 256 or one or more AI productivity tool-enablable software applications 259.

The AI productivity tool module 256 may interface with the information handling system 200 via an AI productivity tool plug-in 258. The AI productivity tool plug-in 258 may be any software or firmware that allows the AI productivity tool module 256 to perform those actions at the information handling system 200 on a query input or generate responsive actions, software services, or responses based on a received query input (e.g., typed or spoken words) from the user. The AI productivity tool plug-in 258 may be used by the AI productivity tool module 256 to interface with any number of AI productivity tool-enablable software applications 259 executing or executable on the information handling system 200 by correlating a query intent value with a capability intent value of one of the AI productivity tool-enablable software applications 259 in an example embodiment.

The information handling system 200 also includes an AI productivity tool subagent 260. The AI productivity tool subagent 260 may be any software and/or firmware executable by the hardware processor 202 of the information handling system 200 to interface one or more of a plurality of the AI productivity tool-enablable software applications 259 (such as remediation (AMDS) software application 278, Dell® Optimizer® software application 280, Dell® Trusted Device® software application 282, Dell® Display and Peripheral Manager® software application 284, AWCC software application 286, Dell® Support Assist® software application 288, virtual assistant module 290) to provide AI enabled capabilities within those AI productivity tool-enablable software applications 259 (e.g., 278, 280, 282, 284, 286, 288, 290). Each may be an on-the-box software application or may be a subagent that links or accesses a cloud-based software system according to embodiments herein. In an embodiment, the AI productivity tool subagent 260 may be used to direct the execution of various modules described herein. Additionally, the AI productivity tool subagent 260 may be provided with access to the BIOS and OS of the information handling system 200 to conduct the AI productivity actions pursuant to the user's query input provided at the AI productivity tool module 256 and an interface to one or more AI productivity tool-enablable software applications 259. Examples of AI productivity tool-enablable software applications 259 may include, for example, Dell® Trusted Device® software application 282, a remediation Dell® APEX Managed Device Service (AMDS)® software application 278, Alienware Command Center (AWCC)® software application 286, Dell® Optimizer® software application 280, Dell® Display and Peripheral Manager software application 284, and a virtual assistant module 290, among others.

In an embodiment, a hardware processor 202 executing computer-readable program code instructions of the AI productivity tool subagent 260 may include a machine learning model requesting module 262. The machine learning model requesting module 262 may be used by the AI productivity tool subagent 260 to, when prompted via the AI productivity tool plug-in 258, request a specific machine learning model algorithm 266 to be used to determine query intent, to correlate to a capability intent, or to execute a capability of one or more AI productivity tool-enablable software applications 259. During operation for example, the machine learning model requesting module 262 may request that one or more machine learning (ML) model algorithms 266 be loaded by the machine learning model loading module 264 such that it is brought up from “cold” stage such as at a solid-state-drive to a RAM memory for immediate access to be used by the AI productivity tool 256 or one or more AI productivity tool-enablable software applications 259. For example, the text or voice input from the user may be processed through a speech recognition model and/or processed through a natural language model in order to determine text or to determine a query intent values of the user's query input to provide a value for meaning of a user's input query for association with responsive intent values including capability intent values. Depending on the operations, a particular ML model algorithm 266 may need to be timely accessible. It is appreciated that these machine learning model algorithms 266 may include one or more algorithms that work together, for example, to both decipher audio input into text if an audio query input is received, and to generate a query intent value from text. The generation of this query intent value in a multi-axis vector space for the user's intent is processed by a hardware processor executing the one or more ML model algorithms needed while also conducting operations at the information handling system 200. The speech to text ML model algorithm may provide text feedback to the user creating AI generated text at a word processing application being executed by the hardware processor 202 on the information handling system 200 in one example embodiment. In other example embodiments, the query intent value may be correlated with a similarity ML model algorithm to provide responsive text or audio feedback to the user such as creating AI generated text at a word processing application being executed by the hardware processor 202 on the information handling system 200. In yet another example embodiment, the query intent value may be correlated with a similarity ML model algorithm to a capability intent value to trigger a responsive action, software service, hardware adjustment or similar action available within available capabilities of the one or more AI productivity tool-enablable software applications. Those responses, responsive action, software service, hardware adjustments, or similar action available within available capabilities may further invoke their own required ML model algorithms 266 to accomplish the responsive action to a user input query.

In an embodiment, the hardware processor 202 executing computer-readable program code instructions of the AI productivity tool subagent 260 also includes a software development kit (SDK) module 270. The SDK module 270 may include any computer-readable program code instructions that is executed by the hardware processor to request that a machine learning model algorithm 266 be provided during the execution of an AI productivity tool-enablable software application 259. For example, where a user interacts with the graphical user interface (GUI) of an AI productivity tool-enablable software application 259 being executed on the video display device 246 and selects an AI productivity tool be used, the SDK module 270 then requests from the AI productivity tool subagent 260 a specific ML model algorithm 266 to be loaded into RAM or maintain there and executed on a first hardware processing device of the information handling system. The selection by the user of the AI productivity tool 256 to work with the AI productivity tool-enablable software application 259, therefore, triggers a process by which a specific ML model algorithm 266 is executed in order to provide to the user the ability to provide a query input at the information handling system 200 in order to receive AI generated output such as a response or a responsive operation, function, software service or other response from one or more capabilities of the AI productivity tool-enablable software applications 259.

In a specific example, the user may be drafting a lengthy document or email and may select a speech-to-text AI productivity tool available within the word processing application or email application (e.g., both examples of an AI productivity tool-enablable software application 259). The selection of this speech-to-text AI productivity tool causes the AI productivity tool software application 260 to execute the SDK module 270 in order to begin the process of communicating this request to a machine learning model requesting module 262 for handling of that request for taking speech input and converting it to text in the email or document. In an embodiment, the SDK module 270 may present the request for the ML model algorithm 266 such that a specific type of ML model algorithm 266 is available in RAM, for example, and has a hardware processor that can perform this task of executing on the information handling system 200 at the selected hardware processing device (e.g., hardware processor 202, EC, GPU, APU, NPU, etc.).

In an embodiment, the AI productivity tool subagent 260 may initially validate the request for the execution of the ML model algorithm 266. This validation process may include, for example, determining whether a specific ML model algorithm 266 or a specific type of ML model algorithm 266 that satisfies the request is available to the information handling system 200. In an example embodiment, the ML model algorithms 266 available at the information handling system 200 may be stored on a memory device (e.g., static memory) and accessible to the AI productivity tool subagent 260 or may be actively used and stored in RAM or stored in an solid state drive or other drive memory on the box of the information handling system. In another example embodiment, the information handling system 200 may be operatively coupled to a server on the network 238 that maintains these ML model algorithms 266. In either of these examples, however, the certain ML model algorithm 266 or type of ML model algorithm 266 may not be available the AI productivity tool subagent 260 may initially determine the availability of these ML model algorithms 266 as a validating step prior to proceeding.

In an embodiment, the request by the SDK module 270 may cause an AI productivity proxy application programming interface (API) 272 to handle the request for a specific ML model algorithm 266 to support a user input or to correlate and determine a response or responsive action with a capability of one of the AI productivity tool-enablable software applications 259 based on an interface contract defining a specific ML model algorithm 266. This interface contract, again, describes the available inputs into the ML model algorithm 266 and the provided outputs from the ML model algorithm 266 that will satisfy the AI productivity tool-enablable software application 259 requirements. This description of the available inputs and outputs associated with the ML model algorithm 266 may be presented as metadata during the request by the AI productivity proxy API 272. For example, a request for a speech-to-text ML model algorithm 266 requires the AI productivity proxy API 272 to screen for and find a ML model algorithm 266 that receives, as input, an audio input (e.g., via microphone 292) and provides, as output, alphanumeric output that transforms spoken words into text. For example, the AI productivity tool module 256 working with one of the AI productivity tool-enablable software applications 259 may request for a speech-to-text ML model algorithm 266 requires the AI productivity proxy API 272 to screen for and find a ML model algorithm 266 that receives, as input, an audio input (e.g., via microphone 292) and provides, as output, alphanumeric output that transforms spoken words into text. In another example embodiment, the AI productivity tool module 256 working with one of the AI productivity tool-enablable software applications 259 may request that any input query be provided with an inference value that is a query intent value of the user's input, such as determined from the text. This query intent value (e.g., from audio input converted to text, or text input from the user) may be correlated with a capability intent of an AI productivity tool-enablable software application 259 with the AI productivity proxy API 272 correlating a query intent value to the capability intent value for response to the user's input queries. Therefore, the AI productivity proxy API 272 is used to interface (e.g., send inputs to and receive outputs from) the AI productivity tool-enablable software application 259 with the selected ML model algorithm 266.

In an embodiment, computer readable code instructions of the AI productivity tool subagent 260 also includes an AI productivity swappable wrapper generator 276. The execution of the computer-readable program code instructions of the AI productivity swappable wrapper generator 276 causes an ML model algorithm wrapper 265 to be created around the chosen ML model algorithm 266 used to service the request by the AI productivity proxy API 272 on behalf of the AI productivity tool-enablable software application 259. This wrapper 265 may be used to wrap a chosen ML model algorithm 266 in a virtual shell of inputs and outputs for the ML model algorithm 266 thereby enabling the ML model algorithm 266 to be run by a hardware processing device 202 or seamlessly switched among a selection of hardware processing devices at the operating system level. In this way, the contract for an AI productivity tool 256 or AI productivity tool-enablable software application 259 may be satisfied by invoking an ML model algorithm run in the background and may be switched between hardware processing devices seamlessly when one particular hardware processing device is detected as reaching resource limits (e.g., reaching or exceeding a processing resource threshold) or the like. In an embodiment, the wrapper 265 generates as a shell for the ML model algorithm 266 to provide a switchable OS level inference runtime library to provide for establishing inputs and outputs to control the hardware processor operation and allow seamless selection among a chipset having plural hardware processors as to which is used to run the underlying ML model algorithm 266. In an embodiment, the wrapper 265 may be any computer-readable program code within a software library that allows the SDK module 170 to call the specific ML model algorithm 266 selected to be invoked on behalf of the AI productivity tool-enablable software application 259 or AI productivity tool subagent 260. In an embodiment, if a CPU reaches a processing resource consumption threshold or maximum, the wrapper 265 enables the system to switch seamlessly to a GPU NPU, APU or other hardware processing resource to access these inputs and outputs to the currently executing ML model algorithm 266 for the AI productivity tool 256 or the AI productivity tool-enablable software application.

When the ML model algorithm wrapper 265 has been generated, the AI productivity tool software application 260 may return a handle of the wrapper 265 to the SDK module 270 which returns the AI productivity proxy API 272 that includes the interface contract and handle to the AI productivity tool 256 or AI productivity tool-enablable software application 259 for use in running the ML model algorithm 266 at whichever hardware processor is being utilized among the available hardware processors on the information handling system. The AI productivity tool-enablable software application 259, in an embodiment, begins to use the ML model algorithm 266 for the AI productivity tool-enablable software application 259 to submit inputs into and receive outputs from the execution of the ML model algorithm 266 via execution by a currently-selected hardware processor 202 as described.

In an embodiment, the AI productivity tool subagent 260 may determine whether or not the AI productivity tool module 256 or AI productivity tool-enablable software application 259 is needing this ML model algorithm 266 or not or if a hardware processor is reaching or exceeding processing resource limits and made to be switched. In an embodiment, the AI productivity tool-enablable software applications 259 operating with the AI productivity tool module 256 may not need a specific ML model algorithm 266 for ongoing operations. In one example instance, the AI productivity tool-enablable software application 259 no longer needs to convert audio input, for example, into text due to the AI productivity tool-enablable software application 259 no longer needing such audio output and receiving only text input. Instead, the ML model algorithm 266 may be switched to another ML model algorithm 266 that does not include a speech recognition ML model algorithm 266 or speech-to-text ML model algorithm 266 such that processing resources are not used to execute those types of ML model algorithms 266 within the combined ML model algorithm 266 that are no longer needed to be invoked on behalf of the AI productivity tool-enablable software application 259.

In an embodiment, where the AI productivity tool-enablable software application 259 working with the AI productivity tool module 256 still needs the ML model algorithm 266 currently selected and loaded onto RAM for execution, the hardware processor 202 may execute computer-readable program code of an inference runtime control module 268. The execution of the computer-readable program code instructions of the inference runtime control module 268 may initially determine whether the current ML model algorithm 266 runtime is appropriate based on current processing conditions at the information handling system 200 along with other factors described herein. In an embodiment where the inference runtime control module 268 determines that the current hardware processor 202 executing the ML model algorithm 266 is reaching a high utilization level the current runtime of the ML model algorithm 266 is causing a high level of resource usage on the existing hardware processor above a threshold maximum, the inference runtime control module 268 may choose a new hardware processor to execute the ML model algorithm 266. In an embodiment, the new hardware processor may be an alternative hardware processor located on the box of the information handling system 200. In some embodiments, an alternative hardware processor of a server located remotely from the information handling system 200 and accessed by the information handling system 200 via the wired or wireless connection to the network 238 as described herein. In this embodiment, the inference runtime control module 268 may select that the inputs be provided to the server, processed by the hardware processor of the server, and receive outputs from the server thereby relying on hardware processing resources available to the information handling system 200 via the server.

During operation, in an example embodiment, a hardware processor executing computer readable code instructions of the inference runtime control module 268 may interface with a quality of service (QOS) metric detection module 274. The computer readable code instructions of the QoS metric detection module 274 may be used to detect QoS metrics via hardware, BIOS, OS, and other sources at the information handling system 200 and provide these QoS metrics to the inference runtime control module 268. In an embodiment, these QoS metrics may include consumption metrics describing consumption levels of processing resources at each of the hardware processing devices (e.g., hardware processor 202, EC, GPU, a microcontroller, etc.), application types being executed on the hardware processing devices, and other QoS metrics that effect the user experience of the information handling system 200. These QoS metrics may be used to determine if and when the hardware processor resource levels reach a maximum or threshold level when an ML model algorithm 266 selected for a particular task or capability is being executed at any particular hardware processing resource on behalf of an AI productivity tool-enablable software application 259 while the hardware processor 202 is also operating other software and tasks for the information handling system 200.

It is appreciated that QoS threshold metrics may be implemented by the inference runtime control module 268 such that when a QoS threshold is reached or exceeded, the inference runtime control module 268 may execute to switch from a first hardware processing device to second hardware processing device and/or from a first ML model algorithm 266 to a second ML model algorithm 266 based on these QoS metrics detected by the QoS metric detection module 274. Additionally, it is appreciated that that QoS threshold metrics may be implemented by the inference runtime control module 268 such that when a QoS threshold is reached or exceeded, the inference runtime control module 268 may proceed to switch from a first ML model algorithm 266 to a second ML model algorithm 266 based on these QoS metrics detected by the QoS metric detection module 274.

For example, where the execution of the first ML model algorithm 266 causes the processing resources of any given hardware processor to reach a maximum or a threshold level based on the QoS metrics, a second ML model algorithm 266 may be selected that may provide similar or same ML capabilities as the first ML model algorithm 266 but with less processing requirements or may be better suited to a different hardware processor. This may be true where the first ML model 266 includes a combination or group of cooperating ML model algorithms 266 that initially provided relatively more capabilities for the AI productivity tool-enablable software application 259, but now include some capabilities that are no longer needed to provide the necessary output to the AI productivity tool-enablable software application 259. For example, the first ML model algorithm 266 may include a combination of a speech recognition ML model algorithm 266, a speech-to-text ML model algorithm, an intent embedding ML model algorithm, and an intent-to-skills detection ML model algorithm among a plurality of ML model algorithms 266. Where an initial audio input from the user via a microphone 292 is provided, the execution of the AI productivity tool-enablable software application 259 may initially provide, as input, this audio data to the combination ML model algorithm 266. However, the user may not continuously provide audio input to the microphone 292 in order to receive output from the ML model algorithm 266 and may use text input, image inputs, or others instead. Thus, the execution of the first ML model algorithm 266 for speech-to-text may be switched to a second ML model algorithm 266 that does not have a or utilize speech recognition or speech-to-text capability within the ML model algorithm 266 thereby reducing the processing requirements during execution of this second ML model algorithm 266. Therefore, the execution of the computer-readable program code instructions of the inference runtime control module 268 may allow for either or both of the switching between hardware processors and ML models based on QOS metrics detected by the QoS metric detection module 274 in embodiments herein.

In one embodiment, the hardware processor (e.g., 202) executes computer-readable program code instructions of the inference runtime control module 268 to invoke the AI productivity swappable wrapper generator 276 to swap between a first ML model algorithm 266 to a second ML model algorithm 266 if an ML model algorithm 266 being invoked is not appropriate for use with a AI productivity tool-enablable software applications 259 for reasons such as the example described above or the operation adjusts to require a different ML model algorithm 266. In such embodiments, during a switch of ML model algorithms 266 a switch between hardware processing devices executing the ML model algorithms 266 may also occur, if appropriate. For example, certain types of processing resources such as an APU or an NPU may be better suited than a CPU to execute an ML model algorithm 266. In an embodiment, switching between hardware processors may include switching between a first hardware processor (e.g., hardware processor 102) on the information handling system 200 to a second hardware processor (e.g., the GPU, an APU, an NPU, etc.) also on the information handling system 200. In an embodiment, switching between hardware processors may include switching between a first hardware processor (e.g., hardware processor 202) on the information handling system 200 to a second hardware processor (e.g., the GPU, an APU, an NPU, etc.) on a remote server wired or wirelessly coupled to the information handling system 200. In an example embodiment where the hardware processing device executing the ML model algorithm 266 is switched from a hardware processing device at the information handling system 200 to a hardware processing device or resource on a server accessible via the network 238, the AI productivity swappable wrapper generator 276 may unwrap the first ML model algorithm 266 and wrap a second ML model algorithm 266 being stored. In an embodiment, the wrapper 265 allows an alternative hardware processor to seamlessly switch from the first ML model algorithm 266 to the second ML model algorithm 266.

In embodiments herein where the switching between hardware processors may include switching between a first hardware processor (e.g., hardware processor 202) on the information handling system 200 to a second hardware processor (e.g., the GPU, an APU, an NPU, etc.) also on the information handling system 200, the AI productivity swappable wrapper generator 276 may unwrap the first ML model algorithm 266 and wrap a second ML model algorithm 266 being stored on a memory device such as a SSD on the information handling system. This is done so that the AI productivity proxy API 272 can communicate the inputs and outputs and from an ML model algorithm 266. The hardware processor (e.g., 202, 104, NPU, APU) and the AI productivity tool-enablable software applications 259, in this example embodiment, therefore, execute and engage the inference runtime control module 268 to orchestrate the switching of hardware processors, seamlessly to the user, during runtime. In an embodiment, the inference runtime control module 268 may also orchestrate the switching from one or a first ML model algorithm 266 to another or a second ML model algorithm 266 as described in some embodiments herein. This ensures and ML model algorithm 266 that is appropriate for the operation of the AI productivity tool-enablable software applications 259 is loaded to main memory 108 form a cold memory storage such as a static memory device or a drive unity for faster access upon switching from a first ML model algorithm 266 to a second ML model algorithm 266.

The systems and methods described herein allow for execution of code instructions of the inference runtime control module 268 of the AI productivity tool subagent 260 to orchestrate the dynamic and user-seamless switching of hardware processors executing ML model algorithms 266. The systems and methods described herein allow for execution of code instructions of the inference runtime control module 268 to further orchestrate switching among ML model algorithms 266 that support an interface contract with the AI productivity tool-enablable software applications 259 being executed on the information handling system 200 via the AI productivity tool module 256 by a hardware processing device to respond to input queries received from a user in further embodiments. The AI productivity proxy API 272 allows for the identification and request process for these various ML model algorithms 266 while the AI productivity swappable wrapper generator 276 may, under the direction of the inference runtime control module 268, swap a wrapper 265 from a first ML model algorithm 266 to a second ML model algorithm 266 as needed depending on any of a plurality of criteria. Those criteria may include determining when the second ML model algorithm 266 is more currently needed or a higher priority, determining that an alternative ML model algorithm 266 will improve operational response and resource utilization by the ML model algorithm to the contract requirements of the currently-executing operations of the AI productivity tool module 256 or AI productivity tool-enablable software application 259, or other similar criteria. This can further improve the operation of the hardware processor 202 and the information handling system 200 according to embodiments herein.

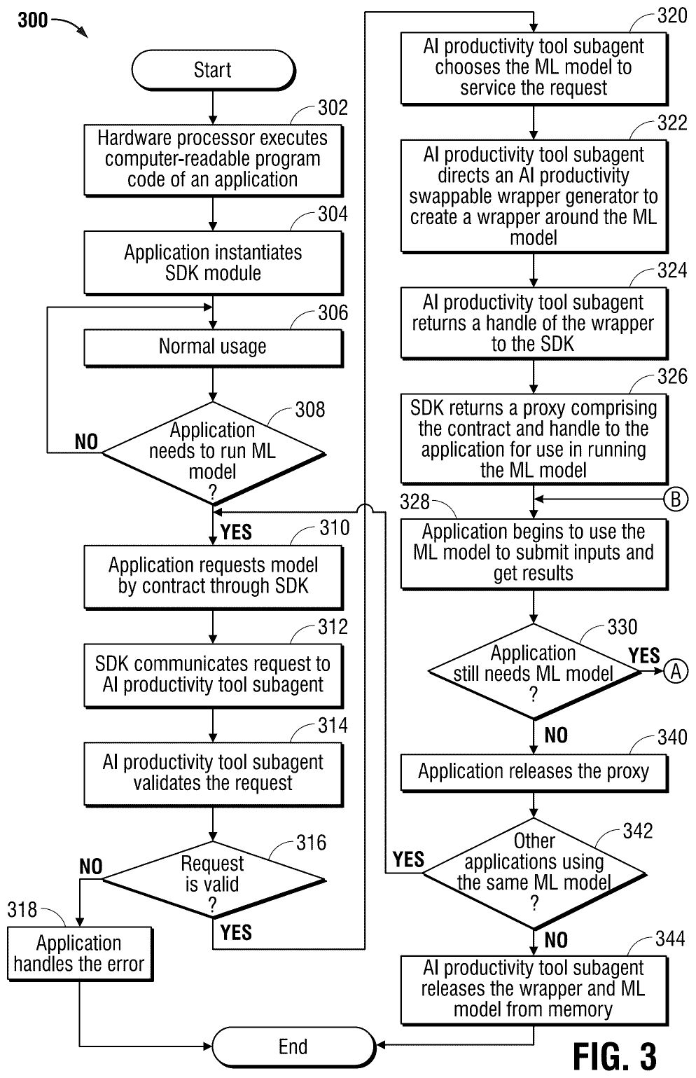

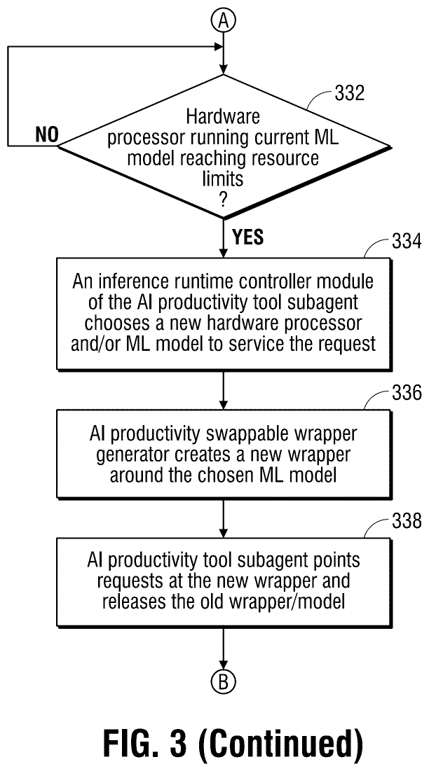

FIG. 3 is a flow diagram showing a method 300 of runtime switching between switching between hardware processing devices executing ML model algorithms and/or between ML model algorithms being utilized with an AI productivity tool module on an information handling system according to an embodiment of the present disclosure. The method 300 described in connection with FIG. 3 may be operated on an information handling system such as an information handling system (e.g., 100, 200) described in connection with FIGS. 1 and/or 2.

The method 300 may include, at block 302, the hardware processor or other hardware processing device of the information handling system executing computer-readable program code instructions of an application, such as one or more software applications or firmware systems. As described herein, this application may include any AI productivity tool-enablable software application described herein and may include plug-in subagent applications that are executed by the hardware processor of the information handling system to link or access a parent software application such as a cloud-based software system according to embodiments herein. For example, an AI productivity tool-enablable software application may include a remediation (AMDS) software application, Dell® Optimizer® software application, Dell® Trusted Device® software application, Dell® Display and Peripheral Manager® software application, AWCC software application, Dell® Support Assist® software application, and plug-in applications associated with a word processing application (e.g., Microsoft® Word®), an email application (e.g., Microsoft® Outlook®, Gmail®, etc.), a spreadsheet application (e.g., Microsoft® Excel®), and a browser application (Google® Chrome®, Microsoft® Edge®, etc.). In an embodiment, the user may provide input to each of these applications using a keyboard, trackpad, or microphone with the use of a local AI productivity tool module software system such as a native virtual assistant or a third-party virtual assistant module installed and executed on the information handling system by a hardware processor.

At block 304, the method 300 includes the hardware processor executing computer readable code instructions of AI productivity tool-enablable software application instantiating a software development kit (SDK) module via the hardware processor (e.g., GPU, CPU, APU, NPU, etc.). The SDK module may include any computer-readable program code instructions that is executed by the hardware processor to request that a machine learning model algorithm be provided during the execution of an AI productivity tool-enablable software application such as when interfacing with a user and supported or assisted by an AI productivity tool module according to embodiments herein.

At block 306, the computer readable code instructions of the AI productivity tool-enablable software application may operate as normal with the user providing input (e.g., voice via a microphone or text via a keyboard) to the AI productivity tool module and which may invoke one or more ML model algorithms selected and invoked by the AI productivity tool-enablable software application. In an embodiment, the request by the SDK module may cause the hardware processor of the information handling system to execute computer-readable program code instructions of an AI productivity proxy API to handle the request for a specific ML model algorithm based on an interface contract defining a specific ML model algorithm such as to be used with the AI productivity tool module and one of the AI productivity tool-enablable software applications or with a specific capability of one of the AI productivity tool-enablable software application.

At block 308, the hardware processor of the information handling system executing computer readable code instructions may determine if the AI productivity tool-enablable software application requires or needs the use of an ML model algorithm to be run and may further determine if at least one type of such an ML model algorithms is available for execution on the information handling system. Again, the interface contract describes the available inputs into an appropriate ML model algorithm and the provided outputs from the ML model algorithm that will satisfy the AI productivity tool-enablable software application requirements or AI productivity tool module requirements to perform a capability for an operation, function, software service or response that is responsive to a user input query into the AI productivity tool module. This description of the available inputs and outputs associated with the ML model algorithm may be presented as metadata during the request by the AI productivity proxy API. For example, a request for a speech-to-text ML model algorithm requires the AI productivity proxy API to screen for and find an ML model algorithm that receives, as input, an audio input (e.g., via microphone) and provides, as output, alphanumeric output that transforms spoken words into text. Therefore, the AI productivity proxy API is used to interface (e.g., send inputs to and receive outputs from) the AI productivity tool-enablable software application with the selected ML model algorithm according to the interface contract and with an ML model algorithm able to provide appropriate outputs to the AI productivity tool-enablable software application.

For example, where a user interacts with the GUI of an AI productivity tool-enablable software application being executed on the video display device and selects an AI productivity tool be used, the SDK module then requests from an AI productivity tool subagent selection of a specific ML model algorithm, from a plurality of ML model algorithms to be loaded and executed on a first hardware processing device of the information handling system. In this case, the request by the AI productivity tool-enablable software application for an ML model algorithm to meet an interface contract requirement to support the AI productivity tool-enablable software application, this indicates the AI productivity tool-enablable software application needs to run the ML model algorithm at block 308. The input query by the user of the AI productivity tool triggering the AI productivity tool to receive and process the input query to initiate the AI productivity tool-enablable software application for a capability response, therefore, sets off a process by which a specific ML model algorithm is executed in order to provide to the user the ability to provide input at the information handling system and in order to receive an AI generated output response or action. Where the hardware processor of the information handling system does not detect input from a user requesting the use of an ML model algorithm at block 308, the method 300 returns to block 306 with the hardware processor continuing to monitor for user input indicative of the need of an ML model algorithm to be executed.

In a specific example, the user may be drafting a lengthy document or email and may select a speech-to-text AI productivity tool plug-in application available within the word processing application or email application (e.g., both examples of an AI productivity tool-enablable software applications). The selection of this speech-to-text AI productivity tool plug-in application causes the AI productivity tool subagent to execute the SDK module in order to begin the process of communicating this request to a machine learning model requesting module for handling of that request. Similarly, other requests such as receiving an input query that requires embedding into a query intent value for similarity association to a response or responsive action may also trigger one or more other AI productivity tool plug-in application and the causes the AI productivity tool subagent to execute the SDK module in order to begin the process of communicating this request to a machine learning model requesting module for handling of that request. This applies to a variety of AI productivity tool-enablable software applications for beginning a process of communicating a request to a machine learning model requesting module for handling of that request to support that executing AI productivity tool-enablable software application.

At block 310, in an embodiment, the SDK module may present the request for the ML model algorithm such that a specific type of ML model algorithm is requested for use with the AI productivity tool module and any AI productivity tool-enablable software applications being used to process and respond to an input query. This ML model algorithm requested that can perform this task may be selected from the ML model algorithms maintained on the information handling system and may be executed on the information handling system at a first hardware processing device (e.g., a hardware processor, an EC, a GPU, etc.). In an embodiment, the ML model algorithm may be a composite or grouping of individual ML model algorithms that work in concert to fulfill the contract for an AI productivity tool-enablable software application or the AI productivity tool module for processing and responding to a query input. For example, the first ML model algorithm may include a combination of a speech recognition ML model algorithm or a speech-to-text ML model algorithm, or an intent detection embedding ML model algorithm in order to receive audio input from a user at a microphone, convert recognize that speech, convert the speech to text, identify an intent, and assign a query intent value to the query input. Further, a similarity correlation query to skill ML model algorithm may be used to correlate the query intent value to a capability intent value.

This method 300 at block 312 may include the SDK module communicating the request to the AI productivity subagent described herein. In an embodiment, the request by the SDK module may cause an AI productivity proxy API to handle the request for a specific ML model algorithm based on an interface contract defining a specific ML model algorithm. This interface contract, again, describes the available inputs into the ML model algorithm and the provided outputs from the ML model algorithm that will satisfy the AI productivity tool-enablable software application requirements. This may include an interface contract for use with the AI productivity tool-enablable software application and AI productivity tool module to process query inputs from a user or generate an AI driven responsive action, software service, operation, hardware adjustment, or responsive communication according to embodiments herein. This description of the available inputs and outputs associated with the ML model algorithm may be presented as metadata during the request by the AI productivity proxy API. For example, a request for a speech-to-text ML model algorithm requires the AI productivity proxy API to screen for and find a ML model algorithm that receives, as input, an audio input (e.g., via microphone) and provides, as output, alphanumeric output that transforms spoken words into text. Therefore, the AI productivity proxy API is used to interface (e.g., send inputs to and receive outputs from) the AI productivity tool-enablable software application with the selected ML model algorithm.

In an embodiment, the method 300 includes executing the computer readable code instructions of the AI productivity tool subagent validating the request at block 314. This validation process may include, for example, determining whether a specific ML model algorithm, group of ML model algorithms, or a specific type/group of ML model algorithm that satisfies the request is available to the information handling system. In one example embodiment, the ML model algorithm available at the information handling system that may satisfy the contract may already be stored at RAM memory and immediately accessible to the AI productivity tool-enablable software application and AI productivity tool module. In another example embodiment, the ML model algorithms available at the information handling system may be stored on a memory device (e.g., static memory) and loadable for use by the AI productivity tool-enablable software application and the AI productivity tool module. In an alternative example embodiment, the information handling system may be operatively coupled to a server on the network that maintains the ML model algorithm or a copy of the ML model algorithm requested and that satisfies the interface contract requirements for the AI productivity tool-enablable software application or AI productivity tool module. In either of these examples, however, the certain ML model algorithm or type of ML model algorithm may not be available the AI productivity tool software application may initially determine the availability of these ML model algorithms as a validating step prior to proceeding. Where, at block 316, it is determine that the request is not valid, the method 300 continues to block 318 with the AI productivity tool-enablable software application handling the error by, for example, informing the user that the system does not have access to the ML model algorithm and cannot process the request without a wired or wireless connection to a remote server where the ML model algorithms. At this point where the validation has failed, the method 300 may end.

Where at block 316, it is determined that the request for the ML model algorithm is valid, the method 300 continues to block 320. At block 320, the AI productivity tool subagent may choose a ML model algorithm that can be used to service the request by the AI productivity tool-enablable software application or AI productivity tool module. At this point, the AI productivity tool subagent may also direct an AI productivity swappable wrapper generator to create a ML model algorithm wrapper around the selected ML model algorithm at block 322. The execution of the computer-readable program code instructions of the AI productivity swappable wrapper generator causes an ML model algorithm wrapper to be created around the chosen ML model algorithm used to service the request by the AI productivity proxy API on behalf of the AI productivity tool-enablable software application or the AI productivity tool module. This wrapper may be used to wrap a chosen ML model algorithm thereby enabling the ML model algorithm to be run by a currently selected hardware processing device at the operating system level and run in the background. Further, the ML model algorithm model enables the wrapped ML model algorithm operating to be seamlessly switched between hardware processing devices when one particular hardware processing device is detected as reaching resource limits (e.g., reaching or exceeding a processing resource threshold) or the like. The ML model algorithm wrapper generates as a shell for the ML model algorithm to provide a switchable OS level inference runtime library to control which hardware processor, in a chipset for an information handling system which has plural hardware processors, is used to run the underlying ML model algorithm 166 providing a virtual shell of inputs and outputs that may be accessed by a currently operating hardware processor as well as switched to execution via an alternatively selected hardware processor.

At block 324, the method 300 includes the AI productivity tool subagent returning a handle of the wrapper to the SDK module. At block 326, the SDK returns the AI productivity proxy API that includes the interface contract and handle to the AI productivity tool-enablable software application operating with the AI productivity tool module for use in running the ML model algorithm. This will permit the AI productivity tool-enablable software application to begin to use the ML model algorithm for the AI productivity tool-enablable software application with the currently operating hardware processor submitting inputs into and receive outputs from the execution of the ML model algorithm using the ML model algorithm wrapper at block 328 in embodiments herein.

At block 328, the method 300 includes the AI productivity tool-enablable software application or AI productivity tool module using the ML model algorithm executing on a first selected hardware processor, which may be a default hardware processor, to process user query inputs by providing those query inputs into and receive outputs from the ML model algorithm. As described herein, the user may provide these inputs via a keyboard, a trackpad, a microphone or any other input device. The inputs received by the ML model algorithm are of the type expected by the type of ML model algorithm chosen. For example, where the type of ML model algorithm originally requested was to service a speech-to-text function at the AI productivity tool-enablable software application, the expected input is an audio input that is picked up by a microphone associated with the information handling system. In another example embodiment, where the type of ML model algorithm originally requested was to service a text input function for an AI driven response or responsive action with an intent embedding ML model algorithms or a similarity query to capability correlation ML model algorithm for the AI productivity tool-enablable software application, the expected input is a text input from a keyboard or the text output of an audio input that has been converted to text as well as the generated query intent as input.

In yet another example embodiment where the selected ML model algorithm selected was to service a battery diagnostic process, the expected input may include voltage levels, amperes levels, and temperature levels associated with the operation of a battery of the information handling system. In an alternative example embodiment, the ML model algorithm may expect input that describes operating characteristics of a battery or other hardware device in the information handling system. These inputs may be of a different type than those input used for a speech-to-text type of ML model algorithm and the metadata associated with the interface contract will include a definition of this type of input to the ML model algorithm and the expected output from the ML model algorithm. It is contemplated that the expected inputs may be audio, text, image, telemetry measurements of hardware component or software operations of the information handling system, stored capability intent values, among others as well as expected outputs from other ML model algorithms such as a generated query intent value in various embodiments. Accordingly, it is contemplated that a variety of ML model algorithms may be implemented for the AI productivity tool module and the AI productivity tool-enablable software applications to provide AI driven responsive actions, hardware operations, software services, or other responses by the information handling system in response to any user query inputs received in various embodiments of the present disclosure.

At block 330, the AI productivity tool subagent may determine whether the AI productivity tool-enablable software application is still in need of the ML model algorithm. In an embodiment, the AI productivity tool-enablable software application may still need the ML model algorithm to be executed if inputs are still being received at the ML model algorithm. For example, where the ML model algorithm is to service a battery diagnostic process, the inputs may be continuously received as long as the information handling system is turned on. Where the information handling system has initiated a shutdown process or the AI productivity tool-enablable software application has finished its operation, the AI productivity tool-enablable software application may not need the ML model algorithm any longer. Where, at block 330, the AI productivity tool subagent has determined that the ML model algorithm is no longer needed, the application may release the proxy associated with the operation of the ML model algorithm at block 340. At block 342, the AI productivity tool subagent may determine whether other AI productivity tool-enablable software applications require the execution of the ML model algorithm. If other AI productivity tool-enablable software applications need the ML model algorithm, the method 300 returns to block 310 and proceeds with the processes as described herein. Where no other AI productivity tool-enablable software application requires that the ML model algorithm be executed, the method 300 may include the AI productivity tool subagent releasing the wrapper and the ML model algorithm from memory at block 344. At this point the method 300 may end.

Where the AI productivity tool-enablable software application still needs the ML model algorithm, the method 300 includes determining, with the inference runtime control module whether the current ML mode runtime is operating via execution on a hardware processing resource that may be reaching a resource utilization maximum threshold level at block 332. The execution of the inference runtime control module may initially determine whether the current hardware processor executing the currently operating ML model algorithm runtime is reaching a high level of resource utilization based on monitored telemetry of current processing conditions of that hardware processor, as well as other available hardware processors, at the information handling system, for example.

In an embodiment, the inference runtime control module may interface with a QoS metric detection module. The QoS metric detection module may be used to detect QoS metrics at the information handling system and provide these QoS metrics to the inference runtime controller module. In an embodiment, these QoS metrics may include consumption metrics describing processing resources at each of the hardware processing devices (e.g., hardware processor such as a CPU, GPU, NPU, APU, EC, a microcontroller, etc.), application types being executed on the hardware processing devices, and other QOS metrics that effect the user experience of the information handling system. It is appreciated that QoS threshold metrics may be implemented by the inference runtime control module such that when a QoS threshold relating to hardware processor resource utilization at a current processor executing a particular ML model algorithm is reached or exceeded, the inference runtime control module may proceed to switch from a first hardware processing device to second hardware processing device having lower processor resource utilization in an embodiment. In another example embodiment, when a QoS threshold for processor resource utilization is reached or exceeded, the inference runtime control module may proceed to switch from a first ML model algorithm to a second ML model algorithm that may be an alternative ML model algorithm that may meet the interface contract requirements of the AI productivity tool-enablable software application based on these QoS metrics detected by the QoS metric detection module. For example, an alternative, second ML model algorithm may require fewer computing resources to execute or the needed capabilities of the interface contract for the AI productivity tool-enablable software application may have changed such that a different second ML model algorithm may be more suited to meet the interface contract requirements. It is appreciated that, in some embodiments, both the swapping of the hardware processors and ML model algorithms may be completed based on the QoS thresholds being reached.

In an embodiment where the execution of computer readable code instructions of the inference runtime control module determines that the current hardware processor executing the runtime of the ML model algorithm has not reached a maximum resource utilization threshold at block 332, the inference runtime control module may continue to monitor whether the use of the selected hardware processor to execute this runtime of the ML model algorithm is appropriate at block 332.

Where execution of the inference runtime control module determines that the current hardware processor executing the runtime of the ML model algorithm exceeds a hardware processing resource utilization level at block 332 risking degradation in performance of the AI productivity tool-enablable software application and the AI productivity tool module, the inference runtime control module may proceed to block 334 to choose a second, alternative hardware processor to execute the ML model algorithm. Seamless switching to the second, alternative hardware processor may be conducted using the ML model algorithm wrapper of the current runtime execution of the ML model algorithm for the inputs to and outputs from the ML model algorithm to the second, alternative hardware processor as described in embodiments herein. In an embodiment, a new, second hardware processor may be an alternative hardware processor located on-the-box or on the information handling system and may include any of a CPU, NPU, GPU, APU and the like. In another embodiment a new hardware processor may be a hardware processor of a server located remotely from the information handling system and accessed by the information handling system via the wired or wireless connection to the network as described herein. In this embodiment, the inference runtime control module may select that the inputs be provided to the server, processed by the hardware processor of the server, and receive outputs from the server thereby relying on hardware processing resources available to the information handling system via the server.

In another embodiment, the and or choose a new ML model algorithm to be executed at block 334 as described in embodiments herein. In some embodiments, where the execution of the first ML model algorithm causes the processing resources of any given hardware processor to reach a maximum or a threshold level based on the QoS metrics, a second ML model algorithm may be selected that may provide similar or same ML capabilities as the first ML model algorithm but with less processing requirements. This may be true where the first ML model includes a combination or group of cooperating ML model algorithms that initially provided relatively more capabilities for the AI productivity tool-enablable software application but now include some capabilities that are no longer needed to provide the necessary output to the AI productivity tool-enablable software application. For example, the first ML model algorithm may include a combination of a speech recognition ML model algorithm, a speech-to-text ML model algorithm 166, and an intent detection ML model algorithm. Where an initial audio input from the user via a microphone is provided, the execution of the AI productivity tool-enablable software application may initially provide, as input, this audio data to the combination ML model algorithm. However, the user may not be required to continuously provide audio input to the microphone in order to receive output from the ML model algorithm. Thus, the execution of the first ML model algorithm may be switched to a second ML model algorithm that does not have a speech recognition and speech to text capability within the ML model algorithm thereby reducing the processing requirements during execution of this second ML model algorithm. Therefore, the execution of the computer-readable program code instructions of the inference runtime control module may allow for either or both of the switching between hardware processors and ML models based on QoS metrics detected by the QOS metric detection module.

The method 300 may include, at block 336, executing the computer-readable program code instructions of the AI productivity swappable wrapper generator to create a new wrapper around the new chosen ML model algorithm if a new ML model algorithm is to be chosen as described in an embodiment of block 334 above. This new wrapper, again, is used to service the request by the AI productivity proxy API on behalf of the AI productivity tool-enablable software application as described herein. This wrapper may be used to wrap this new, selected ML model algorithm thereby enabling the ML model algorithm to be run by a hardware processing device at the operating system level and run in the background. In an embodiment, at block 338, the AI productivity tool software application points its request at the new wrapper and releases the old wrapper and ML model algorithm for use by other AI productivity tool-enablable software applications if necessary. The method 300 then returns to block 328 as described herein.

The systems and methods described herein allow for the hardware processor executing computer-readable program code instructions an inference runtime control module to orchestrate the dynamic and user-transparent switching of ML model algorithms that support an interface contract with the AI productivity tool-enablable software applications being executed on the information handling system by a hardware processing device to respond to input queries received from a user. The AI productivity proxy API allows for the identification and request process for these various ML model algorithms while the AI productivity swappable wrapper generator may, under the direction of the inference runtime control module, provide for seamless switching among hardware processor on-the-box of the information handling system. Further, the AI productivity swappable wrapper generator may swap a wrapper from a first ML model algorithm to a second ML model algorithm where needed to provide for seamless switching of hardware processors as well as ML model algorithms being utilized if needed.

The blocks of the flow diagrams of FIG. 3 or steps and aspects of the operation of the embodiments herein and discussed herein need not be performed in any given or specified order. It is contemplated that additional blocks, steps, or functions may be added, some blocks, steps or functions may not be performed, blocks, steps, or functions may occur contemporaneously, and blocks, steps, or functions from one flow diagram may be performed within another flow diagram.

Devices, modules, resources, or programs that are in communication with one another need not be in continuous communication with each other, unless expressly specified otherwise. In addition, devices, modules, resources, or programs that are in communication with one another can communicate directly or indirectly through one or more intermediaries.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

The subject matter described herein is to be considered illustrative, and not restrictive, and the appended claims are intended to cover any and all such modifications, enhancements, and other embodiments that fall within the scope of the present invention. Thus, to the maximum extent allowed by law, the scope of the present invention is to be determined by the broadest permissible interpretation of the following claims and their equivalents and shall not be restricted or limited by the foregoing detailed description.

What is claimed is:

1. A method of runtime switching between machine learning models comprising:
executing computer-readable program code instructions, via a hardware processor, of a software development kit module with a hardware processor of an information handling system to initiate a request, on behalf of an AI productivity tool-enablable software application being executed on the information handling system, for a first machine learning (ML) model to support execution of the AI productivity tool-enablable software application in responding to received query inputs from a user via an AI productivity tool with AI generated responsive actions;
executing computer-readable program code instructions of a swappable wrapper generator with the hardware processor to create a first wrapper around the first ML model algorithm that is a shell including defined inputs and outputs for a runtime of the first ML model algorithm for interface with the hardware processor to execute the first ML model algorithm with the AI productivity tool-enablable software application;
executing computer-readable program code instructions of an inference runtime control module to monitor the processor resource utilization of the hardware processor executing the runtime of the first ML model algorithm; and
executing computer-readable program code instructions of the inference runtime control module to determine if the hardware processor executing the runtime of the first ML model algorithm on reaches a hardware resource utilization limit; and
executing computer-readable program code instructions of the inference runtime control module to switch from the hardware processor executing the first ML model algorithm to a second hardware processor to execute the runtime of the first ML model algorithm.

2. The method of claim 1 further comprising:
executing computer-readable program code instructions of the inference runtime control module to detect current available processing resources on the information handling system among the hardware processor, the second hardware processor of a plurality of hardware processors on the box of the information handling system.

3. The method of claim 1 further comprising:
executing computer-readable program code instructions of the inference runtime control module to select a second ML model algorithm to provide an alternative service to the request of the first ML model algorithm by the AI productivity tool-enablable software application when the first ML model algorithm is not required to meet the request of the AI productivity tool-enablable software application; and
executing computer-readable program code instructions of the inference runtime control module to cause the swappable wrapper generator to create a second wrapper around the second ML model algorithm and release the first wrapper of the first ML model algorithm.

4. The method of claim 3 further comprising:
executing computer-readable program code instructions of the inference runtime control module to switch from the hardware processor executing the first ML model algorithm to a second hardware processor executing a second runtime of the second ML model algorithm.

5. The method of claim 1 further comprising:
executing computer-readable program code instructions of the inference runtime control module determine if execution of the runtime of the first ML model algorithm is not operating to meet the request of the AI productivity tool-enablable software application by detecting current quality of service metrics on the information handling system, where the quality of service metrics include consumption metrics describing processing resources at each of a plurality of hardware processing devices at the information handling system, application types being executed on the plurality of hardware processing devices, and other quality of service metrics that effect a user experience of the information handling system.

6. The method of claim 1 further comprising:
the software development kit module returning a proxy application program interface comprising a contract defining expected inputs for and expected outputs from the first ML model algorithm for the request from the AI productivity tool-enablable software application executed on the information handling system for use in selecting the first ML model algorithm.

7. The method of claim 1 further comprising:
executing computer-readable program code instructions of the inference runtime control module to select a second ML model algorithm to provide an alternative service to the request of the first ML model algorithm by the AI productivity tool-enablable software application based on a common contract between the first ML model algorithm and the second ML model algorithm.

8. The method of claim 1 further comprising:
executing the computer readable program code of the AI productivity tool software application to determine if the AI productivity tool-enablable software application being executed on the information handling system continues to require the execution of the first ML model algorithm and release a proxy application program interface (API) associated with the first ML model algorithm and release the wrapper and first ML model algorithm from an executable memory for use by other AI productivity tool-enablable software applications executable on the information handling system.

9. An information handling system to coordinate runtimes of machine learning models instantiated at the information handling system comprising:
a hardware processor;
the hardware processor to execute computer-readable program code instructions of a software development kit module of an information handling system to initiate a request, on behalf of an AI productivity tool-enablable software application being executed on the information handling system, for access to a first machine learning (ML) model algorithm in support of execution of the AI productivity tool-enablable software application in responding to received query inputs from a user via an AI productivity tool with AI generated responsive actions;
the hardware processor to execute computer-readable program code instructions of a swappable wrapper generator with the hardware processor to create a first ML model algorithm wrapper around the first ML model algorithm that is a shell including defined inputs and outputs for a runtime of the first ML model algorithm for interface with the hardware processor to execute the first ML model algorithm with the AI productivity tool-enablable software application;
the hardware processor to execute computer-readable program code instructions of an inference runtime control module to determine that the hardware processor executing the runtime of the first ML model algorithm reaches a hardware resource utilization limit; and
the hardware processor to execute computer-readable program code instructions of the inference runtime control module to switch from the hardware processor executing the first ML model algorithm to a second hardware processor to execute the runtime of the first ML model algorithm with the first ML model algorithm wrapper.

10. The information handling system of claim 9 further comprising:
the hardware processing device to execute computer-readable program code instructions of the inference runtime control module to detect current available processing resources of a plurality of hardware processors on the information handling system among including hardware processor and the second hardware processor.

11. The information handling system of claim 9 further comprising:
the hardware processor to execute computer-readable program code instructions of the inference runtime control module to select a second ML model algorithm to provide an alternative service to the request of the first ML model algorithm by the AI productivity tool-enablable software application when the first ML model algorithm is not required to meet the request of the AI productivity tool-enablable software application; and
the hardware processor to execute computer-readable program code instructions of the inference runtime control module to cause the swappable wrapper generator to create a second ML model algorithm wrapper around the second ML model algorithm and release the first ML model algorithm wrapper of the first ML model algorithm.

12. The information handling system of claim 11 further comprising:
the hardware processor to execute computer-readable program code instructions of the inference runtime control module to switch from the hardware processor executing the first ML model algorithm to a second hardware processor executing a second runtime of the second ML model algorithm.

13. The information handling system of claim 9 further comprising:
the hardware processor to execute the computer-readable program code instructions of the inference runtime control module to determine if execution of the runtime of the first ML model algorithm is not operating to meet the request of the AI productivity tool-enablable software application by detecting current quality of service metrics on the information handling system, where the quality of service metrics include consumption metrics describing processing resources at each of a plurality of hardware processors at the information handling system, application types being executed on the plurality of hardware processors, and other quality of service metrics that effect a user experience of the information handling system.

14. The information handling system of claim 9 further comprising:
the hardware processor to execute computer-readable program code instructions of the software development kit module to return a proxy application program interface comprising a contract defining expected inputs for and expected outputs from the first ML model algorithm as well as a handle to the AI productivity tool-enablable software application executing on the information handling system for use in running the first ML model algorithm.

15. The information handling system of claim 9 further comprising:
the hardware processor to execute the computer-readable program code instructions of the inference runtime control module to select a second ML model algorithm to provide an alternative service to the request of the first ML model algorithm by the AI productivity tool-enablable software application based on a common contract between the first ML model algorithm and the second ML model algorithm.

16. An information handling system comprising:
a hardware processor;
the hardware processor to execute computer-readable program code instructions of a software development kit module to initiate a request, on behalf of an AI productivity tool-enablable software application being executed on the information handling system, for a first machine learning (ML) model to support execution of the AI productivity tool-enablable software application in responding to received query inputs from a user via an AI productivity tool with AI generated responsive actions;
the hardware processor to execute computer-readable program code instructions of a swappable wrapper generator with the hardware processor to create a first ML model algorithm wrapper around the first ML model algorithm that is a shell including defined inputs and outputs for a runtime of the first ML model algorithm to interface with the hardware processor to execute the first ML model algorithm with the AI productivity tool-enablable software application;
the hardware processor to execute computer-readable program code instructions of the inference runtime control module to detect current available processing resources on the information handling system among a plurality of hardware processors on the box of the information handling system;
the hardware processor to execute computer-readable program code instructions of an inference runtime control module to determine if the hardware processor executing the runtime of the first ML model algorithm on reaches a hardware resource utilization limit; and
the hardware processor to execute computer-readable program code instructions of the inference runtime control module to switch from the hardware processor executing the first ML model algorithm to a second hardware processor to execute the runtime of the first ML model algorithm via the first ML model algorithm wrapper.

17. The information handling system of claim 16 further comprising:
the hardware processor to execute computer-readable program code instructions of the inference runtime control module to select a second ML model algorithm to provide an alternative service to the request of the first ML model algorithm by the AI productivity tool-enablable software application when the first ML model algorithm is not required to meet the request of the AI productivity tool-enablable software application; and
the hardware processor to execute computer-readable program code instructions of the inference runtime control module to cause the swappable wrapper generator to create a second ML model algorithm wrapper around the second ML model algorithm and release the first ML model algorithm wrapper of the first ML model algorithm.

18. The information handling system of claim 16 further comprising:
the hardware processor to execute computer-readable program code instructions of the inference runtime control module to switch from the hardware processor executing the first ML model algorithm to a second hardware processor executing a second runtime of the second ML model algorithm.

19. The information handling system of claim 16 further comprising:
the hardware processor to execute the computer-readable program code instructions of the inference runtime control module to determine if execution of the runtime of the first ML model algorithm is not operating to meet the request of the AI productivity tool-enablable software application by detecting current quality of service metrics on the information handling system, where the quality of service metrics include consumption metrics describing processing resources at each of the plurality of hardware processors at the information handling system, application types being executed on the plurality of hardware processors, and other quality of service metrics that effect a user experience of the information handling system.

20. The information handling system of claim 16 further comprising:
the hardware processor to execute computer-readable program code instructions of the software development kit module to return a proxy application program interface comprising a contract defining expected inputs for and expected outputs from the first ML model algorithm for the request from the AI productivity tool-enablable software application executed on the information handling system for use in selecting the first ML model algorithm.
